(19) United States
(12) Patent Application Publication
(10) Pub. No.: US 2026/0329266 A1
(43) Pub. Date: Oct. 22, 2026

(54) SYSTEM

(71) Applicant: SoftBank Group Corp., Tokyo (JP)

(72) Inventor: Yoshinori TAGUCHI, Tokyo (JP)

(73) Assignee: SoftBank Group Corp., Tokyo (JP)

(21) Appl. No.: 19/649,170

(22) Filed: Apr. 16, 2026

(30) Foreign Application Priority Data
Apr. 22, 2025 (JP) 2025-070930

(51) Int. Cl. G05B 23/02

(52) U.S. Cl. CPC G05B 23/0264

(57) ABSTRACT

The present invention relates to a system for highly automating and optimizing safety and quality management in a high-risk process in the manufacturing industry, comprises a real-time monitoring unit, a predictive maintenance unit, an automatic quality management unit, and a data analysis and improvement proposal unit, and realizes abnormality detection, a sign of failure, automatic determination of a quality abnormality, and a continuous improvement proposal by integrally analyzing various sensor data such as temperature, vibration, pressure, and an image with each unit using generative AI as an essential element. Thereby, it is possible to comprehensively solve conventional problems such as human error, sudden failure, overlooking of a defective product, recall risk, downtime, personalization of know-how at the site, and information disconnection among locations, and dramatically improve the safety, quality, production efficiency, and competitiveness of the entire company.

### CROSS-REFERENCE TO RELATED APPLICATION

The present application claims priority to and incorporates by reference the entire contents of Japanese Patent Application No. 2025-070930 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is, against the background of the problem that in medium to large-scale manufacturing companies having a high-risk manufacturing process, particularly in automotive, aerospace, heavy industry, and the like, since they have conventionally relied on manual monitoring by humans, periodic maintenance, and quality management based on empirical rules, there are various problems in safety and quality management such as human error, sudden failure of a machine, overlooking of a quality defect, increase in recall risk, prolongation of downtime, personalization of know-how for each site, and inefficiency of information sharing and improvement activities among a plurality of locations, and these problems significantly impair the reliability and production efficiency of the company, to drastically reduce the risk of occurrence of an accident or a defective product and dramatically improve the safety, quality, efficiency, and competitiveness of the entire company by automatically and integrally realizing real-time and highly accurate abnormality detection, early grasping of a sign of failure, automation of quality inspection, and continuous improvement proposal based on data using generative AI.

### SUMMARY OF THE INVENTION

A means for solving the problem according to the present invention is to configure a safety management system comprising a real-time monitoring unit, a predictive maintenance unit, an automatic quality management unit, and a data analysis and improvement proposal unit, wherein the real-time monitoring unit has a function of acquiring real-time data such as temperature, vibration, pressure, current, and image data from a plurality of types of sensors installed at a manufacturing site, analyzing these data using generative AI, and automatically detecting an abnormal value or an abnormal tendency to issue an alert, the predictive maintenance unit has a function of learning and analyzing time-series data obtained from the real-time monitoring unit using the generative AI, predicting a sign of failure or deterioration of a machine with high accuracy, and determining and notifying a necessity of maintenance at an appropriate timing, the automatic quality management unit has a function of analyzing a product image and various sensor data acquired on a manufacturing line using the generative AI, automatically detecting a defective product or a quality abnormality with high accuracy, and removing or marking the corresponding product from the line, the data analysis and improvement proposal unit has a function of integrally analyzing all data collected from the respective units using the generative AI, extracting a tendency or a problem of an entire manufacturing process, automatically generating a specific improvement measure such as reinforcement of a cooling system or review of a quality inspection process, and proposing the specific improvement measure to a person in charge at the site or a manager, and all of these functions automatically operate while cooperating with each other using the generative AI.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

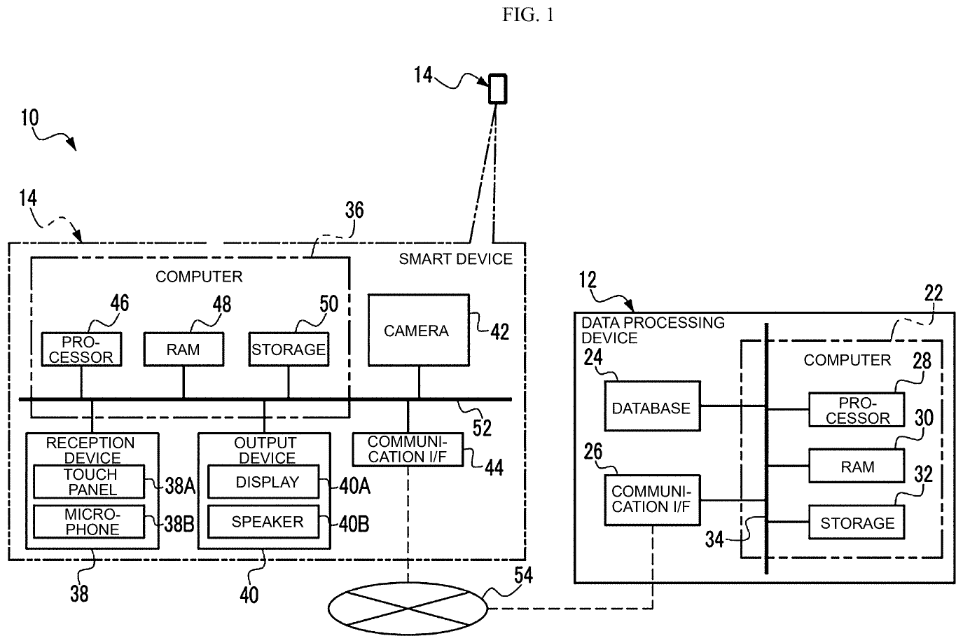

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

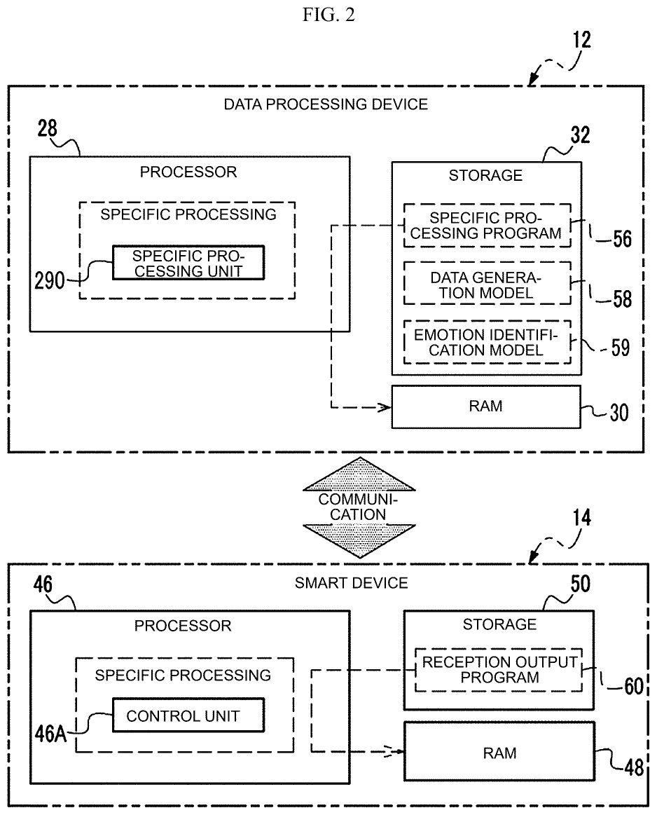

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments for carrying out the present invention will be described more specifically and in detail. The safety management system of the present invention is configured as a network system composed of a server and a terminal, and the function of each unit utilizes generative AI as an essential element to respond to various problems at a manufacturing site in a multilayered and dynamic manner. Specifically, the present safety management system is constructed on a distributed computing environment having a plurality of computing nodes. The present system implements a complex neural network architecture including a large language model and a transformer model for time-series prediction. The present server includes a parallel computing cluster using a graphics processing unit. The present terminal includes an industrial computer having an edge computing function. The present system receives, as an input, multidimensional time-series data sampled at a high frequency from each equipment at the manufacturing site. The present neural network maps the input multidimensional time-series data to a high-dimensional vector space. The present system extracts a hidden correlation between data using a self-attention mechanism. The present system calculates an abnormality probability of the equipment based on the extracted feature amount. The present system generates an abnormality detection signal when the calculated abnormality probability exceeds a predetermined threshold value. The present system transmits the abnormality detection signal to a subsequent control module. Thereby, the present system early discovers a sign of a minute abnormality that has been overlooked by human visual inspection or conventional rule-based threshold determination. The present system prevents an unexpected stop of a manufacturing line. The present system exhibits a technical effect of dramatically improving an operation rate of the equipment. The present system functions particularly effectively in a large-scale production facility such as an automobile manufacturing plant or a semiconductor manufacturing plant. The present system realizes an improvement in computer technology itself, which is an increase in speed of data processing and an improvement in abnormality detection accuracy, rather than mere business efficiency improvement. The present system adopts a hybrid learning method combining supervised learning and self-supervised learning. The present system optimizes a cross-entropy error function and a mean square error function. The present system dynamically updates a weight of the network using a gradient descent method. The present system executes time warping or noise addition to the time-series data as a data augmentation method. The present system thereby enhances generalization performance of the model. The present system receives, as the input data, for example, a 3-axis acceleration tensor sampled at 100 hertz, a 1024-dimensional image feature vector, and a 50-dimensional environmental parameter array. The present system outputs, as output data, for example, an abnormality score in a range of 0.0 to 1.0, a one-hot vector indicating a type of abnormality, and a time stamp indicating a predicted time of occurrence of the abnormality. The present system inputs these output results to an alert generation module. The present system executes a notification routing process according to a degree of urgency in the alert generation module.

First, regarding the real-time monitoring unit, a plurality of types of sensors such as a temperature sensor, a vibration sensor, a pressure sensor, a current sensor, a humidity sensor, a gas detection sensor, a flow rate sensor, an acoustic sensor, an infrared sensor, an image acquisition camera, a thermography camera, and a three-dimensional scanner are installed at the site. For example, in an engine assembly line, temperature, vibration, pressure, and current are monitored for each process, in a welding process, an image of a spark or a weld bead is acquired by a camera, in a painting process, a particle concentration in the air and temperature and humidity are measured, and in a transport device, a current value and vibration of a motor are monitored. Furthermore, for example, optimal sensors are combined for each industry or process, such as a fine particle sensor in a clean room, a gas leak detection sensor in a chemical plant, and an image sensor for detecting foreign matter contamination in a food factory. These sensor data are temporarily collected and preprocessed by a terminal at the site (such as an edge device, an industrial PC, a PLC, or a gateway), and are transmitted to the server through processes such as noise removal, abnormal value correction, and time synchronization. Specifically, the present real-time monitoring unit includes a hardware interface that acquires a plurality of physical quantities. The present monitoring unit converts a continuous physical signal into discrete digital data via an analog-to-digital converter. The present edge device is equipped with a multi-core processor and a dedicated inference accelerator. The present edge device structures the acquired raw data into a multidimensional tensor format. The present edge device expands, for example, vibration data acquired at a sampling rate of 10 kilohertz on a memory as a one-dimensional array of 1000 elements. The present edge device acquires RGB image data obtained from the image acquisition camera as a three-dimensional tensor having a width of 1920 pixels, a height of 1080 pixels, and 3 channels. The present edge device executes a noise removal process using a Kalman filter or a moving average algorithm on these input data. The present edge device applies linear interpolation or spline interpolation to a missing value to perform abnormal value correction. The present edge device executes a time synchronization process with microsecond accuracy using a network time protocol. The present edge device converts the preprocessed data into a feature vector. The present edge device applies, for example, a fast Fourier transform to the vibration data to generate a spectrum vector in a frequency domain. The present edge device transmits these preprocessed data to a central server using a secure communication protocol. The present system performs data preprocessing and feature extraction on an edge side. The present system thereby significantly reduces an amount of data transmitted to the server. The present system exhibits a technical effect of preventing depletion of a communication band and reducing a communication load of the entire network. The present system minimizes a delay in data processing. The present system realizes monitoring with high real-time property. The present system is extremely effective in an application field requiring control in units of milliseconds, such as an automobile engine assembly line or a semiconductor wafer manufacturing process. The present system provides an improvement in a distributed processing architecture using edge computing technology, rather than mere data collection. The present system reduces a calculation load of AI inference processing on a subsequent server side. The present system improves a processing speed of the entire system.

On the server side, the generative AI integrally analyzes these enormous amounts of time-series data and image data. For example, the generative AI collates each type of data with a learned abnormal pattern, such as a rapid rise or periodic abnormal fluctuation of temperature data, detection of an abnormal frequency component by spectrum analysis of vibration data, extraction of a minute fluctuation pattern of pressure data, abnormal color change or shape change of image data, and detection of an abnormal waveform of acoustic data, and when an abnormality is detected, immediately issues an alert from the server to a terminal of a person in charge at the site or a dashboard of a manager. For example, when a minute crack or poor welding is detected from an image of a weld bead, when color unevenness or foreign matter adhesion on a painted surface is detected, or when abnormal vibration or abnormal sound of a motor is detected, an alert content and a notification destination are automatically switched according to a type and a degree of urgency of the abnormality. Furthermore, data before and after the occurrence of the abnormality and related sensor data are automatically recorded and saved, and accumulated in a database for subsequent cause analysis and formulation of a recurrence prevention measure. For example, all sensor data and site camera video from 10 minutes before to 10 minutes after the occurrence of the abnormality are automatically saved and utilized for future re-learning of an AI model or detailed analysis by a human. Specifically, the present server configures a parallel computing cluster including a plurality of graphics processing units. The present server expands a transformer-based neural network for processing multimodal data on a memory. The generative AI receives, as input data, for example, a 1000-dimensional time-series vibration vector, a thermal image tensor of 256 by 256 pixels, and a 50-dimensional environmental parameter array. The generative AI projects these heterogeneous data into a common high-dimensional latent space. The generative AI calculates a complex interaction between data modalities using a self-attention mechanism. The generative AI outputs, as output data, for example, an abnormality probability score in a range of 0.0 to 1.0, a heat map tensor indicating an occurrence location of the abnormality, and a one-hot vector indicating a classification of a cause of the abnormality. The present server sets an abnormality determination flag to true when the output abnormality probability score exceeds 0.85 which is a preset threshold value. The present server activates a subsequent alert generation module based on the abnormality determination flag. The present alert generation module transmits a control signal to the terminal of the manager via a network. The present system thereby specifies a minute abnormal pattern that cannot be discovered by human visual inspection in real time. The present system exhibits a technical effect of dramatically improving accuracy of abnormality detection. The present system is extremely effective in an application field requiring a high degree of safety, such as a chemical plant or a nuclear power plant. The generative AI is pre-learned by self-supervised learning using only past normal data. The generative AI adopts an autoencoder architecture that minimizes a reconstruction error. The generative AI optimizes a weight of the network using a mean square error function. The generative AI uses an adaptive moment estimation method as a gradient descent algorithm. The present system executes random noise addition or time warping to the time-series data as a data augmentation method. The present system thereby improves generalization performance for an unknown abnormal pattern. The present system realizes a fundamental improvement in a data analysis process by a computer, rather than mere automation of business.

Regarding the predictive maintenance unit, time-series data obtained from the real-time monitoring unit is accumulated and analyzed over a long period of time by the generative AI, and a deterioration tendency or a sign of failure or deterioration of a machine for each equipment is predicted with high accuracy. For example, the generative AI automatically extracts an optimal feature amount for each equipment and learns an abnormal tendency or a deterioration pattern, such as performing frequency analysis on vibration data of a bearing to detect an abnormal harmonic component or an amplitude increase, performing multivariate analysis on a current value or temperature data of a motor to extract a pattern different from a normal time, analyzing pressure fluctuation or flow rate data of a hydraulic device to detect a sign of seal deterioration or a leak, analyzing fluctuation in a rotation speed or a load torque of a conveyor to predict wear or belt looseness, and analyzing a change in an operation pattern or power consumption of a welding robot to predict an abnormality in a servomotor or a control system. For example, a failure probability or a remaining life for each equipment is estimated by combining a past failure history and a maintenance history, and a specific prediction result such as “a failure risk of a bearing of an XX device will increase within remaining 100 hours of operation” or “maintenance of a hydraulic pump of a YY line is recommended within one week” is automatically notified from the server to a terminal of a person in charge at the site or a person in charge of maintenance. Furthermore, for example, data of the same type of equipment at a plurality of locations can be cross-sectionally analyzed and utilized for optimization of a company-wide maintenance plan and efficiency improvement of parts inventory management. Specifically, the present predictive maintenance unit implements a long short-term memory network or a transformer model specialized for time-series prediction. The present model uses an enormous amount of history data over the past several months to several years as learning data. The present model receives, as input data, for example, a 720-dimensional time-series vector consisting of an average vibration value every hour for the past 30 days, and a binary matrix indicating a past maintenance record. The present model executes a recursive operation for modeling a temporal dependency relationship on the input time-series vector. The present model dynamically updates a hidden state vector indicating a deterioration state of the equipment. The present model outputs, as output data, for example, a continuous value indicating a remaining operation time until the equipment fails, and a score from 0.0 to 1.0 indicating a failure probability within the next 7 days. The present system generates a maintenance request signal when the output remaining operation time falls below a preset safety margin. The present system collates the maintenance request signal with a parts inventory management database. The present system automatically transmits a request to an ordering system when an inventory of a necessary replacement part is insufficient. The present system thereby prevents an unexpected stop of a production line due to a sudden equipment failure. The present system exhibits a technical effect of reducing a maintenance cost and maximizing an equipment operation rate. The present system is particularly effective in an application field where a stop cost is extremely high, such as a rolling mill in a steelworks or a continuous paper machine in a paper mill. The present model adopts an architecture in which a survival time analysis algorithm and deep learning are fused. The present model is learned using a special loss function considering censored data. The present model optimizes a weight of the network using a backpropagation through time method. The present system provides an improvement in computer technology, which is extraction of a non-linear deterioration pattern in a high-dimensional space, rather than mere statistical prediction. The present system applies a federated learning method that continuously improves prediction accuracy of the model by integrating data of a plurality of locations.

Regarding the automatic quality management unit, a product image and various sensor data acquired on a manufacturing line are multilaterally analyzed by the generative AI, and a defective product or a quality abnormality is automatically detected with high accuracy. For example, an appearance image of a finished product is captured by a high-resolution camera, and a scratch, a dent, coating unevenness, a dimensional abnormality, poor assembly, a label pasting error, a printing error, a color difference, and the like are determined by image recognition by the generative AI. Furthermore, the generative AI integrally analyzes various quality inspection data such as detection of an internal defect by an ultrasonic sensor or an X-ray sensor, detection of a missing part or foreign matter contamination by a weight sensor, confirmation of hermeticity or a leak by a pressure sensor, detection of poor tightening by a torque sensor, and detection of poor conduction or poor insulation by an electrical characteristic sensor. For example, an inspection process that has conventionally relied on human hands is automated, such as detecting a minute crack from an image of a welded portion of a vehicle body, automatically determining poor soldering of an electronic component, or detecting an abnormality in a torque value during assembly of an engine, and a defective product is immediately removed or marked from the line. Furthermore, for example, an inspection result can be displayed in real time to a worker on a site terminal, and the worker can perform re-inspection or correction work on the spot. The inspection result and defective product data are centrally managed by the server, and are also utilized for company-wide quality trend analysis and specification of a cause of a defect. Specifically, the present automatic quality management unit implements a deep convolutional neural network and a semantic segmentation model. The present model receives, as input data, for example, a high-resolution RGB image tensor of 4096 by 4096 pixels, and a 256-dimensional depth vector obtained from an ultrasonic sensor. The present model extracts a spatial feature map from the image through a plurality of convolutional layers and pooling layers. The present model applies a non-linear activation function to the feature map to learn a complex defect pattern. The present model outputs, as output data, for example, coordinate data of a bounding box surrounding a defect region in the image, a class probability distribution indicating a type of defect, and a mask tensor indicating a defect probability in units of pixels. The present system flags the product as a defective product when the output class probability exceeds a determination threshold value. The present system transmits a control pulse to a discharge mechanism on the manufacturing line based on the defective product flag. The present system drives the discharge mechanism to physically exclude the defective product from the line. The present system thereby detects a minute defect exceeding a human visual limit at high speed and stably. The present system exhibits a technical effect of improving accuracy of quality inspection and shortening an inspection time. The present system is effective in an application field requiring an extremely high quality standard, such as a surface mounting process of a printed circuit board or an appearance inspection of a smartphone. The present model is supervised-learned using millions of normal images and abnormal images. The present model optimizes a complex loss function combining a cross-entropy error and a Dice coefficient loss. The present system executes random rotation, inversion, contrast adjustment, and addition of Gaussian noise to the image as a data augmentation method. The present system thereby enhances robustness of the model against a change in lighting conditions or a positional deviation of the product. The present system realizes an improvement in computer technology, which is advanced inference by integrated analysis of multimodal data, rather than mere image processing.

Regarding the data analysis and improvement proposal unit, all data collected from the real-time monitoring unit, the predictive maintenance unit, and the automatic quality management unit are integrally analyzed by the generative AI on the server, a tendency or a problem of an entire manufacturing process is extracted, and a specific improvement measure is automatically generated. For example, the generative AI analyzes multidimensional data such as a past incident log, a quality inspection result, a maintenance history, an equipment operation status, an operation history of a worker, productivity data for each process, energy consumption data, raw material lot information, and external environment data (temperature, humidity, atmospheric pressure, etc.), and automatically generates an improvement proposal optimized for each site, each location, or across the entire company, such as “reinforcement of a cooling system is necessary”, “review of a quality inspection process is effective”, “a work procedure of a specific line should be standardized”, “consideration of changing a supplier of a specific part”, “reinforcement of an education program for workers”, “process reorganization for improving an operation rate of equipment”, and “optimization of an operation pattern for reducing energy consumption”. For example, when a specific defective product rate is high at a certain location, a process or equipment causing the high defective product rate is specified, and a specific countermeasure plan is distributed as a report to a terminal of a person in charge at the site or a manager. Furthermore, the generative AI can also personalize a content of the proposal in consideration of a past response history or a degree of understanding of the person in charge at the site. For example, a proposal conforming to an actual situation of the site is made, such as attaching a detailed procedure manual or a video manual to an inexperienced worker, and notifying only main points to a skilled worker. Specifically, the present data analysis and improvement proposal unit implements a large language model having billions of parameters and a retrieval-augmented generation architecture. The present model receives, as input data, for example, a 1000-row operation log matrix extracted from a structured database, and a text embedding vector of a past trouble report which is unstructured data. The present system converts the input text data into a sequence of integers by a tokenizer. The present model analyzes a contextual meaning of the input sequence using a multi-layer transformer encoder and decoder. The present model outputs, as output data, for example, a natural language text indicating a specific procedure of an improvement measure, a summary text of statistical data serving as a basis for cause analysis, and a list of reference links of related manuals. The present system inputs the output text data to a format conversion module. The present system dynamically generates a report file in an HTML format or a PDF format. The present system transmits the generated report to a terminal of a target person via an e-mail protocol or a dedicated application programming interface. The present system thereby discovers a correlation that is difficult for a human to notice from an enormous and complex data group. The present system exhibits a technical effect of speeding up a decision-making process and automating business improvement. The present system is extremely effective in an application field such as an assembly plant performing high-mix low-volume production or a global manufacturing industry having a complex supply chain. The present model is fine-tuned using a human feedback method from reinforcement learning. The present model optimizes a reward model that evaluates validity and usefulness of the generated text. The present system searches for a past similar case at high speed using a vector database, and adds the past similar case to a prompt as a context. The present system thereby suppresses hallucination and generates an accurate proposal based on facts. The present system provides an improvement in computer technology, which is integrated understanding and logical inference of heterogeneous data, rather than mere text generation.

The functions of these respective units are configured such that the server side executes high-load processing such as large-scale data analysis, model learning, and automatic generation of an improvement proposal by the generative AI, and the terminal side is responsible for collection and temporary processing of sensor data, alert notification and feedback display to a person in charge at the site, and input and confirmation operations by a site worker. For example, distributed processing is also possible in which primary abnormality detection is performed by an edge terminal at the site, and detailed analysis and pattern learning are executed by the server, or image data is acquired by a site terminal, image recognition and determination are performed by the generative AI of the server, and only the result is returned to the terminal. Furthermore, the site terminal can be configured in various forms such as a smartphone, a tablet, a wearable terminal, an industrial PC, and AR glasses, and the site worker can immediately confirm an alert or an improvement proposal and input a response status or a work result on the spot. Specifically, the present system constructs a hierarchical distributed processing architecture composed of an edge computing layer and a cloud computing layer. The present edge terminal holds a lightweight neural network model dedicated to inference in a local memory. The present edge terminal receives, as input data, for example, an image tensor of 30 frames per second streamed in real time from a camera. The present edge terminal executes primary determination with a low delay in units of milliseconds using a model compressed by quantization and pruning techniques. The present edge terminal outputs, as output data, for example, a binary flag indicating a possibility of an abnormality, and a cropped image of a region of interest. The present edge terminal transmits the cropped image to the server only when the binary flag is true. The present server applies a highly accurate neural network model having a larger number of parameters to the received cropped image, and executes a detailed classification process. The present system thereby dramatically reduces consumption of a network band. The present system exhibits a technical effect of improving a response speed of the entire system and optimally allocating calculation resources of the server. The present system is extremely effective in an application field such as a large-scale factory where thousands of pieces of equipment operate or an offshore plant where communication infrastructure is limited. The present system implements a federated learning method. The present edge terminal calculates a weight gradient of the model using local data. The present edge terminal transmits only the calculated weight gradient vector to the server, not raw data. The present server aggregates weight gradient vectors collected from a plurality of edge terminals, and updates a global model. The present system thereby improves generalization performance of the model while protecting data privacy. The present system realizes an improvement in computer technology, which is dynamic task allocation and distributed machine learning, rather than a mere client-server model. The present system transmits spatial anchor data and a rendering command of a three-dimensional object to augmented reality glasses, and superimposes and displays information directly on a field of view of the worker.

Also, for example, in a global company having a plurality of locations, data is aggregated from a terminal of each location to the server, and data analysis and improvement proposal across all locations are executed by the generative AI, whereby advancement of company-wide safety and quality management can be realized. For example, an abnormal pattern or a defective product tendency occurring at a certain location can be immediately shared with other locations, and a preventive measure can be deployed company-wide. Furthermore, for example, a person in charge at the site receives an alert notification or an improvement proposal on a smartphone or a tablet terminal, inputs a response status or a work result on the spot, and feeds back the response status or the work result to the server, whereby the generative AI continuously learns an actual situation of the site, and abnormality detection or an improvement proposal with higher accuracy can be realized. Specifically, the present system constructs a distributed database on a wide area network connecting a plurality of geographically distributed data centers. The present system integrates data asynchronously transmitted from each location into a central data lake using a consistency protocol. The present server implements a graph neural network and models a complex dependency relationship between locations. The present model receives, as input data, for example, a node feature vector indicating an equipment configuration of each location, and an edge weight matrix indicating a parts supply flow between locations. The present model propagates a hidden state vector between nodes using a message passing algorithm. The present model outputs, as output data, for example, a propagation score indicating a probability that a specific abnormal pattern spreads to another location, and a ranking list indicating a priority of preventive maintenance. The present system multicasts a warning packet simultaneously to terminals of all related locations when the output propagation score exceeds a threshold value. The present system thereby predicts a company-wide risk from a local incident, and enables a proactive countermeasure. The present system exhibits a technical effect of unifying global quality standards and advancing risk management. The present system is extremely effective in an application field such as an automobile manufacturer or an electronic device manufacturer having production locations all over the world. The present system analyzes feedback data in a text format input from a site terminal by a natural language processing module. The present system extracts an emotional polarity score and a keyword vector from the feedback data. The present system utilizes the extracted feature amount as a reward signal of reinforcement learning, and dynamically fine-tunes a parameter of the generative AI. The present system thereby continuously adapts an output of the model to an actual need of the site. The present system provides an improvement in computer technology, which is transfer learning and continuous learning of knowledge in a distributed environment, rather than mere data aggregation.

Furthermore, for example, by cooperating with an equipment manufacturer or a parts supplier and linking design information of equipment or traceability information of parts to the server, the generative AI can automatically calculate an optimal maintenance timing or parts replacement timing for each equipment, and notify a person in charge at the site. Also, for example, advanced optimization linked with an external environment can be realized, such as acquiring external weather data or power supply and demand data, optimizing an equipment operation pattern according to a change in temperature or humidity, or automatically adjusting a production schedule for power peak cut. Specifically, the present system includes a dedicated application programming interface gateway for securely communicating with a database of an external organization. The present system establishes a secure data exchange channel using an authentication protocol such as OAuth. The present system receives, as input data, for example, a geometric feature vector of a three-dimensional CAD model provided from an equipment manufacturer, a tensor indicating a material characteristic of a part, and a multidimensional environmental vector including temperature, humidity, and wind speed acquired from an external weather information API. The present system implements a deep reinforcement learning algorithm. The present agent formulates an optimization problem of a production schedule based on a Markov decision process. The present agent defines a current equipment operation status and an external environmental vector as a state space. The present agent defines start/stop timing of each equipment and an adjustment value of an operation parameter as an action space. The present agent outputs, as output data, for example, an operation schedule matrix for minimizing power consumption, and a continuous value vector indicating an optimal set temperature of each equipment. The present system converts the output schedule matrix into a control command interpretable by a programmable logic controller. The present system transmits the control command to each equipment, and drives a physical actuator. The present system thereby realizes advanced autonomous control considering not only internal data but also an external dynamic factor. The present system exhibits a technical effect of dramatically reducing an energy cost and improving efficiency of an entire supply chain. The present system is extremely effective in an application field such as an aluminum smelting plant with high power consumption or an agricultural plant easily affected by weather. The present agent updates weights of a policy network and a value network using a proximal policy optimization algorithm. The present system executes millions of trials and errors in a simulation environment, and pre-learns an optimal policy. The present system provides an improvement in computer technology, which is a solution to a dynamic optimization problem under a complex constraint condition, rather than mere reference to external data.

In this way, the safety management system of the present invention can highly automate and optimize all functions of real-time monitoring, predictive maintenance, automatic quality management, and data analysis and improvement proposal through a cooperative operation of a server and a terminal, various data analysis, learning, and proposal generation by generative AI, and a loop of site feedback, and can dramatically improve safety, quality, and efficiency of a manufacturing site. Furthermore, since it can be flexibly applied to various industries, processes, equipment, and locations at the site, and future expansion and cooperation with other systems are easy, it becomes a system with extremely high practicality, expandability, and competitiveness. Specifically, the present system adopts a microservice architecture, and deploys each functional module as an independent container. The present system dynamically scales a calculation resource of each module according to a load using a container orchestration tool. The present system constructs an integrated data pipeline, and seamlessly processes real-time streaming data and batch processing data. The present system receives, as input data, for example, a multi-thousand-dimensional metric tensor indicating an operation status of the entire system, and a log data stream from each module. The present system implements a meta-learning algorithm, and improves an adaptation speed of a model to a new industry or unknown equipment. The present system outputs, as output data, for example, a resource allocation optimization map of the entire system, and an initial parameter setting vector for new equipment. The present system automatically executes allocation of a virtual machine or control of a network band based on the output optimization map. The present system thereby minimizes an operation cost while maintaining availability of the system at 99.99 percent or more. The present system exhibits a technical effect of ensuring scalability and facilitating system integration. The present system is extremely effective in an application field such as an agile manufacturing environment in which a line configuration is frequently changed or digitalization of a legacy factory in which a plurality of different systems are mixed. The present system automates a pipeline of continuous integration and continuous delivery, and unmannedly performs from re-learning of an AI model to deployment to a production environment. The present system constantly monitors inference accuracy of the model, and automatically triggers a re-learning process when a decrease in accuracy is detected. The present system realizes a technical improvement of an autonomous computing system having self-repair and self-optimization capabilities, rather than a mere collection of software.

### (System Configuration)

The system according to the present embodiment includes a real-time monitoring unit, a predictive maintenance unit, an automatic quality management unit, a data analysis and improvement proposal unit, a user interface unit, a data accumulation unit, and a communication control unit. The real-time monitoring unit has a function of acquiring data in real time from a wide variety of IoT sensors such as a temperature sensor, a vibration sensor, a pressure sensor, a current sensor, a humidity sensor, a gas detection sensor, a flow rate sensor, an acoustic sensor, an infrared sensor, an image acquisition camera, a thermography camera, and a three-dimensional scanner installed at a manufacturing site, and collects data by combining optimal sensors for each site or each process, such as monitoring of temperature, vibration, pressure, and current for each process in an engine assembly line, image acquisition of a spark or a weld bead in a welding process, measurement of an airborne particle concentration or temperature and humidity in a coating process, monitoring of a motor current value or vibration of a transport device, foreign matter detection by a fine particle sensor in a clean room, gas leak detection in a chemical plant, and monitoring by an image sensor for foreign matter contamination detection in a food factory, for example. The real-time monitoring unit temporarily collects and preprocesses these data at a terminal at the site, transmits the data to a server through processing such as noise removal, abnormal value correction, and time synchronization, integrally analyzes enormous amounts of time-series data and image data using generative AI on the server side, performs a rapid rise or periodic abnormal fluctuation of temperature data, detection of an abnormal frequency component by spectrum analysis of vibration data, extraction of a minute fluctuation pattern of pressure data, abnormal color change or shape change of image data, detection of an abnormal waveform of acoustic data, and the like, immediately issues an alert from the server to the terminal at the site or a manager terminal when an abnormality is detected, and automatically records and saves data before and after the occurrence of the abnormality and related sensor data. Specifically, the real-time monitoring unit includes a data collection daemon process implemented on an edge device. This process writes raw data from the sensor to a main memory at high speed without passing through a CPU using direct memory access transfer. The edge device receives, for example, a 12-bit integer array of the pressure sensor sampled at 1-millisecond intervals as input data. The edge device applies a finite impulse response filter to the input array using a digital signal processing library to remove high-frequency noise. The edge device converts the processed data into a floating-point tensor and transmits the tensor to the server using a message queuing protocol. The server caches the received tensor in an in-memory database. The server implements a time-series convolutional network and receives the cached tensor as an input. This network learns long-term time dependence using a dilated convolutional layer. This network outputs, for example, a one-dimensional vector indicating an anomaly score at each time step as output data. The server generates an interrupt process when the anomaly score exceeds a dynamically calculated threshold value. In the interrupt process, the server issues a command to persist all sensor data for 5 minutes before and after the abnormality occurrence time to a disk. Thereby, the system guarantees a complete incident record without data loss. The system exhibits a technical effect of reducing latency of abnormality detection to a millisecond order. The system is extremely effective in an application field requiring an instantaneous judgment, such as monitoring of high-speed rotating equipment. The system provides an improvement in computer technology of optimal task division between an edge and a cloud, rather than mere data transfer.

The predictive maintenance unit has a function of accumulating and analyzing time-series data obtained from the real-time monitoring unit over a long period of time using generative AI, and predicting a deterioration tendency or a sign of failure or deterioration of a machine for each equipment with high accuracy, and the generative AI automatically extracts an optimal feature amount for each equipment and learns an abnormal tendency or a deterioration pattern, such as performing frequency analysis on vibration data of a bearing to detect an abnormal harmonic component or amplitude increase, performing multivariate analysis on a current value or temperature data of a motor to extract a pattern different from a normal time, analyzing pressure fluctuation or flow rate data of a hydraulic device to detect a sign of seal deterioration or leak, analyzing fluctuation in a rotation speed or load torque of a conveyor to predict wear or belt looseness, and analyzing a change in an operation pattern or power consumption of a welding robot to predict an abnormality in a servomotor or a control system, for example. The predictive maintenance unit estimates a failure probability or a remaining life for each equipment by combining a past failure history and a maintenance history, automatically notifies a terminal of a person in charge at the site or a person in charge of maintenance of a specific prediction result such as “a failure risk of a bearing of XX device will increase within remaining 100 hours of operation” or “maintenance of a hydraulic pump of YY line is recommended within one week” from the server, and cross-sectionally analyzes data of the same type of equipment at a plurality of locations to utilize the data for optimization of a company-wide maintenance plan and efficiency improvement of parts inventory management. Specifically, the predictive maintenance unit implements a hybrid architecture combining an autoregressive deep learning model and a probabilistic deterioration model based on a Weibull distribution. This model receives, for example, a three-dimensional time-series matrix consisting of a daily average temperature, a maximum vibration amplitude, and an operating time for the past one year as input data. This model reduces dimensions of the input matrix using a principal component analysis algorithm, and generates a latent feature vector from which an influence of noise is eliminated. This model learns a temporal transition of the latent feature vector using a gated recurrent unit. This model outputs, for example, a continuous value from 0.0 to 1.0 indicating a probability that the target equipment will fail within the next 30 days, and a probability density function of the remaining life as output data. The system activates a maintenance scheduler module when an expected value of the output probability density function falls below a predetermined reference value. The scheduler module collates with a production plan database and calculates an optimal maintenance date and time with the least impact on production. The system push-notifies work instruction data including the calculated date and time to a mobile terminal of the person in charge of maintenance in a JSON format. Thereby, the system reduces excessive periodic maintenance and realizes condition-based maintenance. The system exhibits technical effects of optimizing maintenance costs and minimizing unexpected downtime. The system is extremely effective in an application field where access is difficult and maintenance costs are high, such as jet engine maintenance of an aircraft and turbine management of an offshore wind power generator. This model executes automatic tuning of hyperparameters using Bayesian optimization. The system provides an improvement in computer technology of quantifying uncertainty by fusing probabilistic programming and deep learning, rather than mere statistical inference.

The automatic quality management unit has a function of multilaterally analyzing a product image and various sensor data acquired on a manufacturing line using generative AI, and automatically detecting a defective product or a quality abnormality with high accuracy, and the generative AI integrally analyzes various quality inspection data, such as capturing an appearance image of a finished product with a high-resolution camera and determining a scratch, a dent, coating unevenness, a dimensional abnormality, poor assembly, a label pasting error, a printing error, a color difference, and the like by image recognition using the generative AI, detecting an internal defect by an ultrasonic sensor or an X-ray sensor, detecting missing parts or foreign matter contamination by a weight sensor, confirming hermeticity or a leak by a pressure sensor, detecting poor tightening by a torque sensor, and detecting poor conduction or poor insulation by an electrical characteristic sensor, for example. The automatic quality management unit automates an inspection process that has conventionally relied on human hands, such as detecting a minute crack from an image of a welded part of a vehicle body, automatically determining poor soldering of an electronic component, or detecting an abnormality in a torque value during engine assembly, immediately removes or marks a defective product from the line, displays an inspection result to a worker in real time on a terminal at the site, allows the worker to perform re-inspection or correction work on the spot, centrally manages the inspection result and defective product data on a server, and utilizes the data for company-wide quality trend analysis and identification of a cause of a defect. Specifically, the automatic quality management unit implements an image classification and object detection model based on a vision transformer architecture. This model receives, for example, four 1024 by 1024 pixel image tensors synchronously captured from a plurality of camera angles, and a 100-dimensional time-series waveform vector acquired from the torque sensor as input data. This model divides the image tensor into fixed-size patches, linearly projects each patch, and generates a patch embedding vector. This model simultaneously extracts global context information and a local defect feature in the image using a multi-head attention mechanism. This model outputs, for example, a binary classification score indicating presence or absence of a defect, a four-dimensional bounding box vector indicating coordinates of the defect, and an integer value from 0 to 10 indicating severity of the defect as output data. The system transmits a reject signal to a programmable logic controller when the output binary classification score exceeds 0.9. The system controls a robot arm that has received the reject signal, and moves the defective product to a reject box. Thereby, the system detects a defect with extremely high accuracy even in an environment with a complex background or severe illumination fluctuation. The system exhibits technical effects of reducing a false detection rate and improving inspection throughput. The system is extremely effective in an application field where a minute defect causes a serious result, such as surface inspection of a semiconductor wafer and sterile package inspection of a medical device. This model uses weights pre-trained on a large-scale general image dataset as initial values using a transfer learning method. The system optimizes clustering in an image feature space of a normal product using contrastive learning. The system provides an improvement in computer technology of global feature extraction using a self-attention mechanism, rather than mere image filtering.

The data analysis and improvement proposal unit has a function of integrally analyzing all data collected from the real-time monitoring unit, the predictive maintenance unit, and the automatic quality management unit on a server using generative AI, extracting a tendency or a problem of an entire manufacturing process, and automatically generating a specific improvement measure, and the generative AI analyzes multidimensional data such as a past incident log, a quality inspection result, a maintenance history, an equipment operation status, an operation history of a worker, productivity data for each process, energy consumption data, raw material lot information, and external environment data, automatically generates an improvement proposal optimized for each site, each location, or across the entire company, such as “reinforcement of a cooling system is necessary”, “review of a quality inspection process is effective”, “a work procedure of a specific line should be standardized”, “consideration of changing a supplier of a specific part”, “reinforcement of an education program for workers”, “process reorganization for improving an operation rate of equipment”, and “operation pattern optimization for reducing energy consumption”, for example, specifies a process or equipment causing a high defective product rate of a specific product at a certain location, distributes a specific countermeasure plan as a report to a terminal of a person in charge at the site or a manager, and the generative AI can also personalize a content of the proposal in consideration of a past response history and a degree of understanding of the person in charge at the site, and makes a proposal in line with an actual situation of the site, such as attaching a detailed procedure manual or a video manual for an inexperienced worker and notifying only main points for an expert. Specifically, the data analysis and improvement proposal unit implements a hybrid AI system integrating natural language processing and knowledge graph inference. The system receives, for example, millions of structured records extracted from a relational database and a text corpus extracted from a work standard document in a PDF format as input data. The system extracts entities such as an equipment name, a part name, and an error code from the text using a named entity recognition algorithm. The system constructs a multidimensional knowledge graph on a memory with the extracted entities as nodes and their relationships as edges. The system predicts a hidden link on the knowledge graph using a graph convolutional network. The system outputs, for example, a causal relationship path with a probability indicating a root cause of defect occurrence, and a prompt vector for generating text of an improvement measure as output data. The system inputs the prompt vector into a large language model, and generates a natural language report according to a skill level of a target user. The system automatically publishes the generated report to a dashboard of an internal portal site. Thereby, the system automatically extracts a cross-sectional insight from an enormous amount of siloed data groups. The system exhibits technical effects of dramatically reducing human man-hours required for data analysis and improving quality of decision-making. The system is extremely effective in an application field such as a comprehensive chemical manufacturer manufacturing a wide variety of products and a logistics base managing a complex supply chain. The system receives feedback (binary input of “useful” or “not useful”) from the user. The system uses this feedback as a reward signal, and fine-tunes parameters of the language model by a proximal policy optimization algorithm. The system provides an improvement in computer technology of fusing logical inference using a knowledge graph and natural language generation, rather than mere data visualization.

The user interface unit provides a screen or a dashboard on which a site worker or a manager can operate and confirm various functions of the system, and provides various interfaces such as immediate display of an alert notification, browsing of detailed data when an abnormality occurs, confirmation of a maintenance recommendation, list display of a quality inspection result, reception of an improvement proposal, input of feedback from a site, browsing of a work procedure manual or a video manual, and reference to a past response history on a terminal, a PC, a tablet, a smartphone, a wearable terminal, AR glasses, or the like, for example. Specifically, the user interface unit includes a front-end module that renders a web-based graphical user interface. This module establishes a full-duplex always-on communication channel with the server using a WebSocket protocol. This module asynchronously receives a real-time data stream in a JSON format transmitted from the server. This module dynamically updates a graph or a numerical value on the screen without reloading the entire page using a virtual DOM technology. The system draws a three-dimensional digital twin model of manufacturing equipment on a browser using a WebGL library. The system receives, for example, array data indicating a temperature of each part of the equipment as input data. The system dynamically changes a color of a surface texture of the three-dimensional model based on the temperature data, and visualizes the color as a heat map. The system transmits, for example, a screen transition command according to a user's tap operation or text data from an input form to the server as output data. The system transmits spatial mapping data and an image tensor for superimposed display to augmented reality glasses. The system overlays and displays a work procedure or an abnormal part directly in a field of view of the worker. Thereby, the system significantly reduces a cognitive load on the worker. The system exhibits technical effects of improving visibility of information and dramatically increasing a response speed. The system is extremely effective in a use case such as maintenance and inspection work of a chemical plant where complex piping is intricate, or assembly work where both hands are occupied. The system adopts a responsive design, and automatically optimizes a layout according to a screen resolution of a device. The system provides an improvement in computer technology of data representation optimized for human visual characteristics and real-time drawing, rather than a mere enumeration of information.

The data accumulation unit centrally saves all sensor data, image data, acoustic data, inspection results, incident logs, maintenance histories, work histories, improvement proposal histories, and the like in time series, and utilizes them for future re-learning of an AI model, detailed analysis by a human, audit response, ensuring traceability, and the like. Specifically, the data accumulation unit includes a distributed storage system capable of managing petabyte-class data. This accumulation unit implements a column-oriented database specialized for time-series data. This accumulation unit temporarily saves sensor data flowing in at high frequency in a ring buffer on a memory. This accumulation unit asynchronously writes the data to a disk when a certain chunk size is reached. This accumulation unit applies run-length encoding and a dictionary compression algorithm when writing data. Thereby, this accumulation unit dramatically reduces consumption of storage capacity. This accumulation unit saves unstructured data such as image data and acoustic data together with metadata using an object storage system. This accumulation unit receives, for example, a JSON payload including 100,000 sensor readings per second as input data. This accumulation unit parses the payload and constructs an index using a time stamp as a primary key. This accumulation unit adds a digital signature for falsification detection using a secure hash algorithm to each data record. This accumulation unit cryptographically guarantees integrity and traceability of data. This accumulation unit has a function of extracting accumulated past data as a data set for re-learning of a subsequent neural network. This accumulation unit outputs, for example, millions of rows of data matching a specified period and condition in a multidimensional tensor format or a Parquet format that can be directly read by a machine learning framework as output data. Thereby, the system dramatically improves read/write performance of large-scale data. The system exhibits a technical effect of reducing latency of data retrieval to a millisecond order. The system is extremely effective in an application field requiring high traceability, such as long-term preservation of an engine manufacturing record of an aircraft and response to strict regulatory requirements in pharmaceutical manufacturing. The system realizes an improvement in computer technology itself of improving a data access speed and optimizing storage efficiency, rather than mere data preservation.

The communication control unit controls data transmission and reception between a terminal at the site and a server, between a plurality of locations, and with an external system, and responds to various communication protocols and security requirements, such as real-time transfer of sensor data, immediate distribution of an alert notification, batch transmission of image data, cooperation with an external cloud service, information cooperation with an equipment manufacturer or a parts supplier, and acquisition of weather data or power supply and demand data, for example. Specifically, the communication control unit implements a lightweight messaging protocol based on a publish-subscribe model. This control unit executes asynchronous data routing via a message broker. This control unit establishes a strong encrypted communication path by a transport layer security protocol in communication between an edge device and the server. This control unit constantly monitors a bandwidth and a packet loss rate of a network. This control unit receives, for example, a traffic statistics vector acquired from a network interface card as input data. This control unit executes an adaptive bit rate control algorithm that dynamically increases a compression rate of transmission data when a communication environment deteriorates. This control unit executes a quality control process of temporarily stopping transmission of high-resolution image data with low importance and prioritizing transmission of an abnormality detection alert with high urgency. This control unit provides a RESTful application programming interface for cooperation with an external system. This control unit periodically acquires a multidimensional environment vector including, for example, temperature, humidity, and precipitation from an external weather data server. This control unit converts, for example, the acquired environment vector into an internal standardized JSON format and transfers the vector to the predictive maintenance unit as output data. Thereby, the system guarantees arrival of an important control signal even under an unstable network environment. The system exhibits technical effects of dramatically improving reliability and real-time property of communication. The system is extremely effective in a use case such as a steelworks having a vast site and a mining site in a remote area where communication infrastructure is fragile. This control unit realizes high-speed binary communication between microservices using a remote procedure call framework. The system provides an improvement in network technology of dynamic bandwidth control and priority routing, rather than mere data transmission and reception.

Specific examples of a prompt sentence to be read by generative AI necessary for carrying out the present invention include, for example, “detect an abnormal pattern from time-series data of temperature, vibration, pressure, current, and image data of a manufacturing line, extract data before and after the occurrence of the abnormality, and estimate a cause of the abnormality”, “predict a next maintenance recommended timing from bearing vibration data and a maintenance history for the past one year”, “automatically determine a defective product from a product appearance image and inspection data, and explain a basis for determination”, “integrally analyze quality inspection results, incident logs, and equipment operation data of all locations, and propose five specific improvement measures for quality improvement and downtime reduction”, and “generate an optimal improvement proposal and procedure manual in consideration of a past response history and a degree of understanding of a site worker”. These prompt sentences can be flexibly designed and expanded according to an actual situation and purpose of a site, and are important elements for maximizing learning and inference capabilities of the generative AI. Specifically, the system includes a dedicated prompt engineering module for processing a prompt sentence described in a natural language. This module converts an input text character string into an integer token ID array using a subword tokenizer. This module inputs the token ID array to an embedding layer, and maps the array to a high-dimensional dense vector representation. The system receives, for example, an extended prompt tensor obtained by combining related context data retrieved from a database (for example, a list of past similar error codes and a specification parameter matrix of equipment) in addition to the vector representation of the prompt sentence as input data. The generative AI calculates a dependency relationship between respective words in the prompt using a self-attention mechanism in a process of passing through several tens of layers of transformer blocks. The generative AI outputs, for example, a vocabulary-size vector indicating a probability distribution of a next following word at each time step as output data. The system generates a sequence of words with the highest probability using a beam search algorithm. The system inputs the generated text to a parser, and converts the text into an executable system command or structured JSON data. Thereby, the system converts an ambiguous human instruction into a strict processing flow interpretable by a computer. The system exhibits technical effects of enhancing intuitiveness of a user interface and realizing programming-less complex data analysis tasks. The system is extremely effective in an application field such as a small to medium-sized manufacturing site where a data scientist is absent, and a production management department where rapid decision-making is required. The system uses a rule-based engine that dynamically generates a prompt template in combination, and filters hallucination of AI based on a physical constraint. The system provides an improvement in computer technology of complex system control through a natural language interface, rather than mere text processing.

### (Implementation Steps)

Step 1: Collection and Preprocessing of Sensor Data Data is collected in real time from a wide variety of IoT sensors, such as a temperature sensor, a vibration sensor, a pressure sensor, a current sensor, a humidity sensor, a gas detection sensor, a flow rate sensor, an acoustic sensor, an infrared sensor, an image acquisition camera, a thermography camera, and a three-dimensional scanner, installed in each process and equipment at a manufacturing site. The data is temporarily accumulated in a terminal at the site (such as an edge device, an industrial PC, a PLC, or a gateway), subjected to preprocessing such as noise removal, abnormal value correction, time synchronization, and data compression, and transmitted to a server. For example, temperature, vibration, pressure, and current are monitored in an engine assembly line, an image of a spark or a weld bead is acquired in a welding process, an airborne particle concentration, temperature, and humidity are measured in a coating process, and a current value and vibration of a motor are monitored in a transport device. Specifically, the present system secures a ring buffer on a memory of the edge device and receives an asynchronous data stream from each sensor. The edge device receives, as input data, for example, a one-dimensional waveform array of the acoustic sensor acquired at a sampling frequency of 50 kilohertz and a two-dimensional temperature distribution matrix of the thermography camera acquired at 60 frames per second. The edge device executes a short-time Fourier transform on the waveform array to generate a spectrogram tensor in a time-frequency domain. The edge device applies a median filter to the temperature distribution matrix to remove spike noise. The edge device synchronizes internal clocks of all sensor nodes on a network with sub-microsecond accuracy using a precision time protocol. The edge device adds a synchronized time stamp to each data point. The edge device outputs, as output data, for example, a binary payload obtained by compressing the preprocessed spectrogram tensor and temperature distribution matrix using a Zstandard algorithm. The edge device streams and transmits this binary payload to a central server via a secure socket connection. Thereby, the present system completely offloads a preprocessing load on the server side. The present system exhibits a technical effect of dramatically improving data quality while minimizing consumption of a network bandwidth. The present system is extremely effective in application fields such as a large-scale oil refinery plant in which tens of thousands of sensors operate and an automated warehouse requiring high-speed robot control. In the abnormal value correction, the edge device calculates a Z-score based on a past moving average and standard deviation, and automatically clips a statistical outlier. The present system provides an improvement in computer technology, which is not a mere data pass-through but advanced signal processing and data compression on the edge side.

Step 2: Real-time Abnormality Detection by Generative AI On the server side, the generative AI is caused to read the sensor data and the image data, and integrally analyzes enormous amounts of time-series data and image data. The generative AI performs a rapid rise or periodic abnormal fluctuation of temperature data, detection of an abnormal frequency component by spectrum analysis of vibration data, extraction of a minute fluctuation pattern of pressure data, abnormal color change or shape change of image data, detection of an abnormal waveform of acoustic data, and the like, and when an abnormality is detected, immediately issues an alert from the server to the terminal at the site or a terminal of a manager, and automatically records and saves data before and after the occurrence of the abnormality and related sensor data. Specific examples of a prompt sentence to be read by the generative AI include “Detect an abnormal pattern from time-series data of temperature, vibration, pressure, current, and image data of a manufacturing line, extract data before and after the occurrence of the abnormality, and estimate a cause of the abnormality”. Specifically, the server decompresses the received compressed binary payload on a memory and reconstructs it as a multidimensional tensor. The server loads a deep learning model corresponding to a multimodal input into a video memory of a graphics processing unit. The model receives, as input data, for example, a preprocessed 128 by 128 spectrogram tensor and a 256-dimensional time-series sensor vector. The model generates an integrated feature vector in which a feature of the acoustic data and a feature of the vibration data are fused using a cross-attention mechanism. The model inputs the integrated feature vector to a fully connected layer and executes a non-linear transformation. The model outputs, as output data, for example, a softmax probability distribution for three classes of normal, mild abnormality, and severe abnormality, and an attention weight vector indicating a contribution degree of a sensor variable causing the abnormality. The server generates a critical alert event when the probability of the severe abnormality exceeds 0.95. The server immediately routes the alert event to a notification service using an event-driven architecture. At the same time, the server issues a query to a database management system to move all data for 10 minutes before and after the corresponding time from a cold storage to a hot storage. Thereby, the present system realizes advanced abnormality detection based on a complex correlation among a plurality of sensors. The present system exhibits a technical effect of discovering an unknown failure mode that is impossible by threshold determination of a single sensor. The present system is extremely effective in application fields such as a polymer manufacturing process involving a complex chemical reaction and a semiconductor exposure apparatus in which minute vibration is directly linked to a yield. The model calculates a reconstruction error in a latent space of a variational autoencoder, and executes calculation of an abnormality score by unsupervised learning in parallel. The present system provides an improvement in computer technology, which is not a mere application of a rule but dynamic analysis of multimodal data in a high-dimensional space.

Step 3: Predictive Maintenance Determination by Generative AI Time-series data obtained from the real-time monitoring unit is accumulated and analyzed over a long period of time by the generative AI, and a deterioration tendency or a sign of failure or deterioration of a machine for each equipment is predicted with high accuracy. For example, the generative AI automatically extracts an optimal feature amount for each equipment and learns an abnormal tendency or a deterioration pattern, such as performing frequency analysis on vibration data of a bearing to detect an abnormal harmonic component or amplitude increase, performing multivariate analysis on a current value or temperature data of a motor to extract a pattern different from a normal time, analyzing pressure fluctuation or flow rate data of a hydraulic device to detect a sign of seal deterioration or leak, or analyzing fluctuation in a rotation speed or load torque of a conveyor to predict wear or belt looseness. Specific examples of a prompt sentence to be read by the generative AI include “Predict a recommended timing for next maintenance from bearing vibration data and a maintenance history for the past one year” and “Detect a sign of failure from time-series data of equipment and calculate a recommended maintenance timing”. Specifically, the predictive maintenance unit implements a time-series prediction model based on a long short-term memory network or a transformer architecture. The model receives a multidimensional time-series tensor as input data. This input tensor is, for example, a three-dimensional numerical matrix including vibration acceleration, temperature, and a current value for the past one month. The present system automatically complements a missing value included in the input data by a linear interpolation algorithm. The present system executes a standardization process so as to have zero mean and unit variance in order to unify a scale of each sensor data. The processing unit executes a fast Fourier transform on the input data. The processing unit converts data in a time domain into data in a frequency domain. The model extracts the converted frequency spectrum as a feature amount vector. The neural network is composed of an input layer, a plurality of hidden layers, and an output layer. The present system adopts a rectified linear unit function as an activation function of the hidden layer. The present system suppresses a vanishing gradient problem and stabilizes learning of a deep network. The model calculates a dependency relationship between respective time steps using a self-attention mechanism. The model generates a continuous value score indicating a remaining life of each equipment as output data. The model simultaneously outputs a probability distribution from zero to one indicating a failure probability. The present system determines whether or not the output failure probability exceeds a preset threshold value. The present system transmits a trigger signal to a subsequent maintenance scheduling module when the threshold value is exceeded. In a learning process of the model, the present system uses a mean square error as a loss function. The present system uses an adaptive moment estimation method as an optimization algorithm. The present system dynamically attenuates a learning rate according to progress of learning. The present system arranges a dropout layer in the network in order to prevent overlearning. The present system randomly invalidates some neurons during training. The present system normalizes an output of each mini-batch using a batch normalization layer. The present system dramatically improves a convergence speed of learning. The present system captures a minute deterioration sign that cannot be visually confirmed by a human by calculation in this high-dimensional space. The present system significantly improves accuracy of failure prediction as compared with conventional rule-based threshold determination. The present system prevents sudden equipment stoppage. The present system brings about a technical effect of maximizing an operation rate of a factory. The present system is applied to various industrial devices requiring continuous operation, such as a press machine of an automobile manufacturing line and a vacuum pump of a semiconductor manufacturing apparatus. The present system tokenizes the input prompt text by a natural language processing model. The present system combines the tokenized vector and the time-series feature amount vector. The present system executes multimodal inference. The present system outputs a specific maintenance procedure based on an inference result as text data. The present system displays the output text data on a display of the terminal of the manager. The present system uses past maintenance history data for fine-tuning of the natural language processing model. The present system causes the model to store a deterioration pattern specific to the equipment. The present system adds an equipment identification ID as a part of an input vector during inference. The present system realizes prediction in consideration of an individual difference for each equipment. The present system calculates a contribution degree of a feature amount serving as a basis of a prediction result. The present system outputs a weighting score of attention as visualization data. The present system enables the manager to intuitively understand validity of prediction. The present system executes these processes at high speed on a parallel computing cluster using a graphics processing unit. The present system completes prediction for thousands of pieces of equipment in real time.

Step 4: Automatic Quality Inspection and Defective Product Determination by Generative AI A product image and various sensor data acquired on a manufacturing line are multilaterally analyzed by the generative AI, and a defective product or a quality abnormality is automatically detected with high accuracy. For example, an appearance image of a finished product is captured by a high-resolution camera, and a scratch, a dent, coating unevenness, a dimensional abnormality, poor assembly, a label pasting error, a printing error, a color difference, and the like are determined by image recognition by the generative AI, and the generative AI integrally analyzes various quality inspection data such as detection of an internal defect by an ultrasonic sensor or an X-ray sensor, detection of a missing part or foreign matter contamination by a weight sensor, confirmation of sealability or a leak by a pressure sensor, detection of poor tightening by a torque sensor, and detection of poor conduction or poor insulation by an electrical characteristic sensor. Specific examples of a prompt sentence to be read by the generative AI include “Automatically determine a defective product from a product appearance image and inspection data, and explain a basis for determination” and “Integrate various sensor data and image data, and determine presence or absence of a quality abnormality”. Specifically, the automatic quality inspection unit implements a deep convolutional neural network or a transformer architecture for image recognition. The model receives a high-resolution image tensor as input data. This input tensor is, for example, a three-dimensional array having three channels of red, green, and blue with a resolution of 1024 by 1024 pixels. The present system executes preprocessing of contrast enhancement and noise removal filtering on the input image. The present system applies random rotation or inversion processing of an image as a data augmentation technique. The present system improves generalization performance of the model. The network extracts a local edge or texture feature from the image using a plurality of convolutional layers. The network reduces a spatial dimension of a feature map using a pooling layer. The network acquires global context information of the entire image using a self-attention layer. The model generates a four-dimensional vector indicating coordinates of a bounding box surrounding a defect region as output data. The model simultaneously outputs a class probability distribution vector indicating a type of defect. The present system determines whether or not a maximum value of the output probability distribution exceeds a preset quality standard threshold value. The present system recognizes the product as a defective product when the threshold value is exceeded. The present system transmits a discharge command signal to a programmable logic controller in order to remove the product recognized as a defective product from the line. In a learning process of the model, the present system calculates a cross entropy error as a loss function. The present system updates a weight of the network using an adaptive learning rate optimization algorithm. The present system realizes high-speed and uniform quality determination independent of human visual inspection by this non-conventional image processing method. The present system dramatically improves detection accuracy of a minute scratch or color unevenness that is easy to miss with human eyes. The present system brings about a technical effect of completely preventing outflow of a defective product to a market. The present system is applied to various manufacturing sites requiring strict quality management, such as a surface mounting line of an electronic board and a package inspection process of a food factory. The present system integrates a one-dimensional numerical vector from an ultrasonic sensor or a weight sensor in addition to image data. The present system combines an image feature amount and a numerical feature amount using a multimodal fusion layer. The present system simultaneously determines an abnormality not only in appearance but also in internal structure. The present system analyzes the input prompt text by a natural language processing model. The present system generates a region of interest in the image serving as a basis of a determination result as a heat map. The present system automatically creates an inspection report by integrating the generated heat map and explanatory text. The present system saves the created report in a quality management database. The present system executes these enormous tensor operations in parallel on a dedicated tensor processing unit. The present system completes real-time inspection without delaying a tact time of the line.

Step 5: Data Analysis and Improvement Proposal Generation by Generative AI All data collected from the real-time monitoring unit, the predictive maintenance unit, and the automatic quality management unit is integrally analyzed by the generative AI on the server, a tendency or a problem of an entire manufacturing process is extracted, and a specific improvement measure is automatically generated. For example, the generative AI analyzes multidimensional data such as a past incident log, a quality inspection result, a maintenance history, an equipment operation status, an operation history of a worker, productivity data for each process, energy consumption data, raw material lot information, and external environment data, and automatically generates an improvement proposal optimized for each site, each location, or across an entire company, such as “reinforcement of a cooling system is necessary”, “review of a quality inspection process is effective”, “a work procedure of a specific line should be standardized”, “consider changing a supplier of a specific part”, “reinforce an education program for workers”, “process reorganization for improving an operation rate of equipment”, and “operation pattern optimization for reducing energy consumption”. Specific examples of a prompt sentence to be read by the generative AI include “Integrally analyze quality inspection results, incident logs, and equipment operation data of all locations, and propose five specific improvement measures for quality improvement and downtime reduction” and “Generate an optimal improvement proposal and procedure manual in consideration of a past response history and a degree of understanding of a site worker”. Specifically, the data analysis unit implements a composite architecture combining a large language model and a graph neural network. The model receives a multidimensional state vector including an operation parameter of each equipment in a factory as input data. The model simultaneously receives an adjacency matrix indicating a physical and logical connection relationship between equipment as an input. The present system structures these heterogeneous mixed data as a knowledge graph. The present system embeds each node and edge in a low-dimensional continuous vector space. The network propagates feature information between adjacent nodes using a graph convolutional layer. The network models a complex interaction of the entire factory. The model generates a text token sequence of a natural language from an embedding vector using a transformer decoder. The model generates a numerical vector of an optimized equipment control parameter as output data. The model simultaneously outputs text data constituting a specific improvement proposal. The present system transmits the output numerical vector to a control server of each equipment via a network. The present system automatically updates a control parameter. The present system displays the generated text data on a user interface of a dashboard for a manager. In a learning process of the model, the present system acquires a general feature representation from large-scale manufacturing log data using a self-supervised learning method. The present system further applies reinforcement learning based on a proximal policy optimization algorithm. The present system learns a policy for maximizing production efficiency through trial and error in a simulation environment. The present system automatically specifies a hidden bottleneck that cannot be discovered from a single data source by this advanced abstraction and inference processing. The present system converts an improvement activity depending on tacit knowledge of a skilled manager into a data-driven type. The present system brings about a technical effect of dramatically improving productivity of the entire factory. The present system is applied to an environment having many variables and difficult to optimize, such as a machining factory performing high-mix low-volume production and a chemical plant having a complex supply chain. The present system analyzes the input prompt text by an attention mechanism. The present system dynamically limits a search range in the knowledge graph according to an intention of the prompt. The present system adds a profile vector indicating a skill level of a worker as a conditioning input of a language model. The present system generates procedure manual text in a plain expression according to a degree of understanding of the worker. The present system converts the generated procedure manual into voice data by a voice synthesis engine. The present system provides voice guidance through a speaker at the site or a wireless earphone of the worker. The present system executes these inference processes while performing load balancing on a distributed computing environment. The present system completes analysis within a practical time even for enormous data on a company-wide scale.

Step 6: Notification, Feedback, and Site Response by User Interface Through a user interface unit, a screen or a dashboard on which a site worker or a manager can operate and confirm various functions of the system is provided, enabling immediate display of an alert notification, browsing of detailed data when an abnormality occurs, confirmation of a maintenance recommendation, list display of a quality inspection result, reception of an improvement proposal, input of feedback from a site, browsing of a work procedure manual or a video manual, reference to a past response history, and the like. For example, a site worker receives an alert notification or an improvement proposal on a smartphone or a tablet terminal, inputs a response status or a work result on the spot, and feeds it back to the server, whereby the generative AI continuously learns an actual situation of the site, and realizes highly accurate abnormality detection and improvement proposal. Specifically, the user interface unit implements a neural network for a recommendation system and a reinforcement learning agent. The model receives a sequence vector indicating a past operation history of a user as input data. The model simultaneously receives a context vector indicating a current system state as an input. The present system executes preprocessing of normalizing raw data such as tap coordinates and a scroll amount of the user and converting it into a feature amount vector. The network performs a non-linear transformation of an input vector using a multilayer perceptron. The network calculates an action value of each display item using a Q-learning algorithm. The model generates two-dimensional coordinate data indicating a layout configuration of a user interface as output data. The model simultaneously outputs a continuous value score indicating a priority of each information to be displayed on a screen. The present system drives a screen rendering engine based on the output score. The present system executes rendering for highlighting information with high priority at the center or top of the screen. The present system acquires text data or a selection operation input by the user on the terminal as a feedback signal. The present system inputs this feedback signal to a reward function of reinforcement learning. The present system updates a policy parameter of the agent using a temporal difference learning method. The present system gives a positive reward to an information presentation pattern determined to be useful by the user. The present system gives a negative reward to information ignored by the user. The present system realizes personalized information presentation most suitable for a skill level of the user and a current work situation by this adaptive learning mechanism. The present system significantly reduces a cognitive load of the worker. The present system brings about a technical effect of dramatically improving a response speed when an abnormality occurs. The present system is applied to a site where a worker is forced to make a quick decision, such as a steelworks having a vast site or a data center where a large number of devices are densely packed. The present system performs sentiment analysis on the input text feedback by a natural language processing model. The present system adds a keyword vector extracted from the text to a retraining data set of an abnormality detection model. The present system continuously integrates tacit knowledge of the site into a knowledge base of the system. The present system acquires line-of-sight tracking data of the user during reproduction of a video manual. The present system analyzes a line-of-sight vector and a frame image of a moving image in synchronization. The present system automatically specifies a part that the user has difficulty understanding. The present system generates a control signal for pop-up displaying additional supplementary text for the specified part. The present system executes these interactive processes on an edge device with low latency. The present system provides a smooth operation experience independent of a communication status of a network.

### (Specific Use Case)

For example, when the safety management system of the present invention is applied in an assembly factory of automobile parts, first, a wide variety of IoT sensors such as a temperature sensor, a vibration sensor, a pressure sensor, a current sensor, an image acquisition camera, an acoustic sensor, a humidity sensor, and a flow rate sensor are installed in each process of an assembly line. These sensors collect optimal data for each process in real time, such as monitoring of tightening torque of various parts in an engine assembly process, image acquisition of a weld bead in a welding process, detection of color unevenness or foreign matter adhesion on a coated surface in a coating process, monitoring of a motor current value or vibration of a transport device, and abnormality monitoring of pressure or temperature in a vehicle body assembly process. A terminal at the site temporarily accumulates these data, performs preprocessing such as noise removal, abnormal value correction, and time synchronization, and then transmits the data to a server. Specifically, an edge computing device of the present system implements a lightweight one-dimensional convolutional neural network. The device receives, as input data, an analog signal having a sampling rate of 10,000 times per second acquired from various sensors. The device converts a raw signal into discrete digital data using an analog-to-digital converter. The device executes preprocessing of applying a low-pass filter to remove high-frequency electrical noise. The device performs strict time synchronization processing using a network time protocol in order to correct a deviation in sampling timing among a plurality of sensors. The device applies a spline interpolation algorithm to a missing value to ensure continuity. The network extracts a local fluctuation feature from a time-series waveform using a one-dimensional convolutional layer. The network compresses a weight parameter of a model from a 32-bit floating point to an 8-bit integer using a quantization technique. The device generates a normalized time-series feature amount tensor as output data. The device simultaneously outputs a binary flag indicating presence or absence of an abnormality in an initial stage. The device executes control logic for transmitting high-resolution raw data to a cloud server only when the binary flag indicates an abnormality. The device normally transmits only the compressed feature amount tensor. The device encrypts data using an advanced encryption standard algorithm during transmission. In a learning process of the device, the present system uses a knowledge distillation method. The present system transfers an output distribution of a large-scale teacher model on a cloud to a lightweight student model on an edge. The present system updates a weight of the student model so as to minimize a Kullback-Leibler divergence. The present system significantly reduces a communication bandwidth to the cloud by this distributed processing architecture. The present system realizes real-time abnormality detection in units of milliseconds on the edge side while preventing network congestion. The present system brings about a technical effect of eliminating a control delay due to a communication delay. The present system is applied to a manufacturing site requiring extremely severe real-time performance, such as control of a robot arm operating at high speed and a laser processing machine requiring accuracy in units of milliseconds. The device applies an inter-frame difference method to a video stream from an image acquisition camera. The device crops only a moving region to generate an image tensor. The device combines the generated image tensor with the time-series feature amount tensor on a time stamp basis. The device constructs a multimodal data package. The device publishes the data package to the server using a message queuing telemetry transport protocol. The device temporarily caches data in a built-in solid state drive when a network is disconnected. The device automatically executes retransmission processing after communication recovery. The device constructs a robust data collection infrastructure that completely prevents data loss.

On the server side, the generative AI integrally analyzes these time-series data and image data, and performs, for example, a rapid rise or periodic abnormal fluctuation of temperature, detection of an abnormal frequency component by spectrum analysis of vibration data, extraction of a minute fluctuation pattern of pressure data, abnormal color change or shape change of image data, and detection of an abnormal waveform of acoustic data. When an abnormality is detected, an immediate alert is issued from the server to a terminal at the site or a terminal of a manager, and data before and after the occurrence of the abnormality and related sensor data are automatically recorded and saved. For example, an alert content or a notification destination is automatically switched according to a type or urgency of an abnormality, such as when a minute crack or poor welding is detected from an image of a weld bead, when color unevenness or foreign matter adhesion on a coated surface is detected, or when abnormal vibration or abnormal sound of a motor is detected. Specifically, the server implements a multimodal deep learning model equipped with a cross-attention mechanism. The model receives a time-series feature amount tensor transmitted from an edge device as input data. The model simultaneously receives an image feature amount tensor acquired from a camera as an input. The present system applies a linear transformation layer that projects data of different modalities into a common latent vector space. The network calculates a correlation between a fluctuation pattern of time-series data and a visual change of image data using a cross-attention layer. The network synchronously evaluates, for example, timing of a temperature rise and occurrence of smoke on an image. The model generates a continuous value score from zero to one hundred indicating a degree of abnormality of the entire factory as output data. The model simultaneously outputs a class probability distribution vector indicating a root cause of the abnormality. The present system determines whether or not the output abnormality degree score exceeds a dynamically set threshold value. The present system multicasts an emergency stop signal to all related edge devices when the threshold value is exceeded. The present system automatically snapshot-saves all sensor data for five minutes before and after an abnormality occurrence time in a high availability database. The present system refers to a routing table based on the type of abnormality and the calculated urgency score, and determines an optimal notification destination. The present system transmits an alert to a smartphone of the determined notification destination using a push notification protocol. In a learning process of the model, the present system uses a contrastive learning method. The present system optimizes a network such that different sensor data at the same time approach each other and data at different times move away from each other in a multimodal representation space at a normal time. The present system minimizes a noise contrastive estimation loss function. The present system discovers a complex abnormality undetectable by a single sensor at an early stage by this multimodal integrated analysis in a high-dimensional space. The present system dramatically reduces a false alarm rate. The present system brings about a technical effect of preventing a fatal accident such as a large-scale incident or a fire. The present system is applied to a highly dangerous facility in which a plurality of physical quantities are complexly intertwined, such as a plant involving a chemical reaction and a high-temperature and high-pressure boiler facility. The present system executes preprocessing of extracting a mel-frequency cepstrum coefficient for acoustic data. The present system combines the extracted acoustic feature amount with an image and a time-series feature amount. The present system executes inference integrating three different modalities. The present system activates a generative language model when an alert is issued. The present system dynamically generates natural language text describing a situation of an abnormality and a recommended initial response procedure. The present system attaches the generated text to an alert message. The present system supports a site worker to immediately take a correct action without hesitation. The present system distributes these heavy inference processes to a plurality of graphics processing units. The present system suppresses latency from data arrival to alert issuance within several tens of milliseconds.

Furthermore, in the predictive maintenance unit, characteristic data for each equipment, such as vibration data of a bearing, a current value of a motor, pressure fluctuation of a hydraulic device, fluctuation in a rotation speed or load torque of a conveyor, and a change in an operation pattern or power consumption of a welding robot, is accumulated over a long period of time, and the generative AI learns an abnormal tendency or a deterioration pattern. For example, a failure probability or a remaining life for each equipment is estimated by combining a past failure history or maintenance history, and a specific prediction result such as “a failure risk of a bearing of an engine assembly line increases within remaining 100 hours of operation” or “maintenance of a servomotor of a welding robot is recommended within one week” is automatically notified from a server to a terminal of a person in charge at the site or a person in charge of maintenance. Specifically, the predictive maintenance unit implements a deep learning model integrating a variational autoencoder and a survival time analysis algorithm. The model receives a multivariate time-series matrix including a cumulative operation time of equipment, a history of load torque, and a transition of environmental temperature as input data. The present system executes preprocessing of applying a moving average filter to input data to extract a long-term trend component. An encoder part of the network maps input data to a low-dimensional latent variable vector using a multilayer convolutional layer. A decoder part of the network reconstructs original time-series data from a latent variable vector. The model inputs the extracted latent variable vector to a survival time analysis module. The module estimates a shape parameter and a scale parameter of a Weibull distribution by a neural network. The model generates a probability density function indicating a remaining life of each equipment as output data. The model simultaneously outputs a numerical vector of a 95% confidence interval indicating uncertainty of prediction. The present system calculates an expected value of a probability density function and determines a next optimal maintenance date and time. The present system transmits data to an enterprise resource planning system via an application programming interface when the determined date and time is within a certain period from a current time. The present system confirms an inventory of a necessary replacement part, and executes automatic ordering processing when the part is insufficient. In a learning process of the model, the present system calculates a composite loss function including a reconstruction error and a Kullback-Leibler divergence. The present system further updates a weight of a network so as to maximize a partial likelihood function using a time until actual failure occurrence. The present system realizes risk evaluation considering variation in prediction instead of mere point estimation by this probabilistic approach. The present system minimizes unexpected downtime while reducing excess inventory of parts. The present system brings about a technical effect of optimizing a maintenance cost. The present system is applied to infrastructure equipment in which a part replacement cost is extremely high and an influence at the time of failure is enormous, such as jet engine maintenance of an aircraft and turbine blade management of a wind power generator. The present system vectorizes a past maintenance history by a natural language processing model. The present system combines a semantic feature amount such as “out of grease” or “abnormal wear” extracted from text with a latent variable vector. The present system executes highly accurate life prediction in which numerical data and text data are fused. The present system inputs a prediction result to a natural language generation model. The present system generates easy-to-understand warning text avoiding technical terms. The present system push-transmits the generated text and graph drawing data of a probability density function to a tablet terminal of a person in charge of maintenance. The present system enables a person in charge to visually and intuitively grasp a state of equipment. The present system periodically updates an inference result of a prediction model by batch processing. The present system always maintains a maintenance plan based on latest data.

In the automatic quality management unit, a product image and various sensor data acquired on a manufacturing line are multilaterally analyzed by generative AI, and a defective product or a quality abnormality is automatically detected with high accuracy. For example, an appearance image of a finished product is captured by a high-resolution camera, and a scratch, a dent, coating unevenness, a dimensional abnormality, poor assembly, a label pasting error, a printing error, a color difference, and the like are determined by image recognition using the generative AI, and the generative AI integrally analyzes a wide variety of quality inspection data such as detection of an internal defect by an ultrasonic sensor or an X-ray sensor, detection of a missing part or foreign matter contamination by a weight sensor, confirmation of sealability or a leak by a pressure sensor, detection of poor tightening by a torque sensor, and detection of poor conduction or poor insulation by an electrical characteristic sensor. An inspection result and defective product data are centrally managed by a server and displayed in real time to a worker on a terminal at the site, and the worker can also perform re-inspection or correction work on the spot. Specifically, the automatic quality management unit implements an abnormality detection model using a generative adversarial network. The model receives three-dimensional point cloud data and a high-resolution two-dimensional image tensor of a product flowing on the manufacturing line as input data. The system executes preprocessing of performing voxelization processing on the point cloud data and converting it into uniform three-dimensional grid data. A generator of the network learns a data distribution of a normal product and generates pseudo normal product data from an input latent vector. A discriminator of the network calculates a difference in feature distribution between the input actual inspection data and the pseudo data created by the generator. The model quantifies how much the actual data deviates from the distribution of the normal product as an abnormality score. The model generates heat map image data indicating a degree of abnormality in each part of the product as output data. The model simultaneously outputs a continuous value score from zero to one indicating a comprehensive quality evaluation. When the quality score falls below an allowable threshold value, the system registers a unique identification number of the corresponding product in a defective product database. The system wirelessly transmits the heat map image data to augmented reality glasses worn by a worker at the site. The system executes rendering processing for superimposing and displaying an abnormal part in red on the actual product in a visual field of the worker. In a learning process of the model, the system executes an adversarial learning process based on a minimax game. The system alternately optimizes the generator and the discriminator, and causes the model to acquire various variations of the normal product. The system adopts a semi-supervised learning method in which learning is performed using only data of the normal product. The system exhibits high generalization performance even for an unknown defect pattern that is not defined in advance by this non-conventional generation-based abnormality detection method. The system significantly shortens a construction period of an inspection model at the time of launching a new product. The system brings about a technical effect of reducing a cost of quality assurance in high-mix low-volume production. The system is applied to a field requiring extremely high accuracy, such as manufacturing of a medical implant having a complex shape or inspection of a semiconductor wafer having a fine circuit pattern. The system converts one-dimensional waveform data from the ultrasonic sensor into a two-dimensional spectrogram image by short-time Fourier transform. The system combines the converted spectrogram with the appearance image tensor in a channel direction. The system simultaneously evaluates a surface scratch and an internal cavity defect by a single network. The system transmits a re-inspection result or a correction completion flag input by the worker on the terminal to the server. The system accumulates this feedback data as teacher data for fine-tuning the model. The system constructs a loop for continuously improving inspection accuracy through operation at the site. The system executes these processes by a dedicated inference accelerator on an edge server. The system realizes real-time feedback synchronized with a moving speed of the line.

In the data analysis and improvement proposal unit, all data collected from the real-time monitoring unit, the predictive maintenance unit, and the automatic quality management unit are integrally analyzed by generative AI on a server, a tendency or a problem of an entire manufacturing process is extracted, and a specific improvement measure is automatically generated. For example, the generative AI analyzes multidimensional data such as a past incident log, a quality inspection result, a maintenance history, an equipment operation status, an operation history of a worker, productivity data for each process, energy consumption data, raw material lot information, and external environment data, and automatically generates an improvement proposal optimized for each site, each location, or across the entire company, such as “necessity of reinforcement of a cooling system”, “effectiveness of review of a quality inspection process”, “necessity of standardization of a work procedure of a specific line”, “consideration of change of a supplier of a specific part”, “reinforcement of an education program for workers”, “process reorganization for improving an operation rate of equipment”, and “operation pattern optimization for reducing energy consumption”. It is also possible to personalize a content of the proposal in consideration of a past response history and a degree of understanding of a person in charge at the site. Specifically, the data analysis and improvement proposal unit implements an architecture integrating a deep reinforcement learning algorithm and a natural language generation model. The model receives a high-dimensional environmental state vector including a production plan of a factory, a current inventory level, an operation rate of each equipment, and energy consumption as input data. The system executes preprocessing of converting raw material lot information and a worker ID, which are categorical variables, into a numerical vector by one-hot encoding. The network is configured using an actor-critic method. An actor part of the network outputs a probability distribution of an optimal action policy from the current state vector. A critic part of the network estimates a value of the current state and guides learning of the actor. The model inputs the determined optimal policy as prompt text to the natural language generation model. The model generates a continuous value vector indicating an adjustment value of a conveyor speed or a cooling water temperature of a production line as output data. The model simultaneously outputs a text token sequence describing a specific work instruction or improvement proposal for a worker at the site. The system transmits the output adjustment value vector to a programmable logic controller, and automatically changes a physical operation parameter of the equipment. The system displays the generated text data on digital signage at the site. In a learning process of the model, the system executes a simulation using a digital twin environment. The system updates a weight of the network so as to maximize a reward function that achieves both maximization of a production amount and minimization of energy consumption through trial and error in a virtual space. The system ensures stability of learning using a proximal policy optimization algorithm. The system solves a complex trade-off problem in which a large number of variables that cannot be intuitively grasped by a human are intertwined by dynamic optimization based on this reinforcement learning. The system realizes objective and optimal decision-making exceeding an empirical rule of an expert manager on a company-wide scale. The system brings about a technical effect of dramatically improving overall equipment effectiveness of the entire factory. The system is applied to a manufacturing line of consumer goods with severe demand fluctuation, a large-scale chemical plant where reduction of energy cost is a supreme proposition, and the like. The system uses a past response history vector of the worker as a query of an attention mechanism. The system dynamically adjusts an appearance probability of a technical term in an output layer of the language model. The system executes personalization processing of generating a detailed procedure manual with an illustration for an inexperienced worker and generating short text of only main points for an expert. The system collects an evaluation score from the site for the generated improvement proposal. The system uses the evaluation score as an additional reward signal for reinforcement learning. The system runs a continuous model improvement cycle incorporating human feedback. The system asynchronously executes these calculations in a distributed computing cluster on a cloud. The system continuously searches for an optimal improvement measure in the background without hindering daily production activities.

Specific examples of a prompt sentence to be read by the generative AI include “detect an abnormal pattern from time-series data of temperature, vibration, pressure, current, and image data of a manufacturing line, extract data before and after the occurrence of the abnormality, and estimate a cause of the abnormality”, “predict a next maintenance recommended timing from bearing vibration data and a maintenance history for the past year”, “automatically determine a defective product from a product appearance image and inspection data, and explain a basis for the determination”, “integrally analyze a quality inspection result, an incident log, and equipment operation data of all locations, and propose five specific improvement measures for quality improvement and downtime reduction”, and “generate an optimal improvement proposal and procedure manual in consideration of a past response history and a degree of understanding of a worker at the site”. Specifically, the system implements a transformer-based large language model as a prompt processing engine. The model receives a one-dimensional array of token IDs obtained by dividing text input by a user in subword units as input data. The system performs tokenization while retaining a raw context without executing natural language preprocessing such as stop word removal or stemming on the input text. The network maps discrete token IDs to a high-dimensional continuous vector space using an embedding layer. The network adds positional encoding to retain word order information. The network calculates a dependency relationship between respective words in the context and aggregates information using a multi-head self-attention mechanism extending over several tens of layers. The model generates a vocabulary-size vector indicating a probability distribution of a next appearing word as output data. The model autoregressively generates a token and constructs final response text. The system searches for a word sequence having the highest cumulative probability from among a plurality of generation candidates using a beam search algorithm, and selects optimal text. The system inputs the generated text to a parser, and automatically extracts an executable system command or database query. The system transmits the extracted command to a back-end control module, and triggers actual data extraction or analysis processing. In a learning process of the model, the system executes pre-learning using a large-scale technical document, a past incident report, and an equipment manual. The system further applies reinforcement learning based on human feedback, and fine-tunes the model so as to generate a specialized answer specialized for a domain of a manufacturing site. The system enables even a worker at the site without programming knowledge to execute complex data analysis or system control using everyday language by this advanced natural language understanding capability. The system removes a barrier of a human-machine interface. The system brings about a technical effect of promoting democratization of data utilization and dramatically improving a problem-solving speed at the site. The system is applied to a global factory where multinational workers are mixed, a small-to-medium-sized manufacturing site where an IT expert is not permanently stationed, and the like. The system maps a keyword such as “temperature” or “vibration” included in the prompt to a related sensor ID on a vector space. The system dynamically acquires corresponding sensor data from an external time-series database in an inference process of the language model. The system executes a retrieval-augmented generation method of embedding the acquired numerical data in a text prompt. The system suppresses hallucination and generates accurate cause estimation or improvement proposal based on facts. The system inputs the generated procedure manual text to a machine translation model. The system outputs multilingual text tailored to a native language of the worker in real time. The system executes these natural language processes with low latency on a dedicated inference server. The system provides an interactive and smooth user experience.

As described above, the safety management system of the present invention can highly automate and optimize each function of real-time monitoring, predictive maintenance, automatic quality management, and data analysis and improvement proposal by generative AI in various processes, equipment, and locations of a manufacturing site, and can dramatically improve safety, quality, and efficiency at the site. Specifically, the safety management system is constructed as a distributed processing system based on a microservice architecture. The system receives multi-stream data asynchronously transmitted from all edge devices in a factory as input data. This input data is an aggregate of terabyte-class time-series tensors, image matrices, and text logs generated every second from thousands of sensor nodes. The system executes preprocessing of temporarily buffering inflowing data using a message queuing system and smoothing a traffic spike. The system manages each containerized AI inference module by an orchestration tool. The system executes each task of real-time monitoring, predictive maintenance, and quality management in parallel as an independent process. The system exchanges an intermediate feature amount vector between the respective modules using a shared memory or a high-speed remote procedure call. The system generates a comprehensive index score indicating a health state of the entire factory as output data. The system simultaneously outputs a status vector indicating an operation status or a resource usage rate of each subsystem. The system persists the comprehensive index score in a time-series database and uses it for long-term trend analysis. The system executes auto-scaling of a cloud resource based on the status vector, and dynamically increases or decreases the number of virtual machines according to a calculation load. In a learning process of the system, the system adopts a federated learning method. The system aggregates only a gradient vector of a model calculated at each factory location to a central server. The system updates a weight parameter of an integrated global model without taking raw data outside. The system eliminates a single point of failure of the system and ensures extremely high availability and fault tolerance by this autonomous decentralized architecture. The system maintains a monitoring function of the entire factory even if some nodes go down. The system brings about a technical effect of simultaneously and continuously improving a security level and production efficiency of the entire company. The system is applied to a multinational company having a plurality of production locations around the world, a huge manufacturing ecosystem that performs data linkage across an entire supply chain, and the like. The system includes an ensemble learning layer that integrates inference results of the respective modules. The system quantifies a degree of influence of specific equipment deterioration on quality by multiplying a detection result of a quality abnormality and a prediction result of equipment vibration. The system draws a simulation result of return on investment on a dashboard for management based on the calculated influence degree score. The system seamlessly connects physical data at the site to a management decision-making index. The system processes these complex data pipelines at high speed by optimized routing on a software-defined network. The system completely digitalizes a physical space of a factory and realizes an intelligent manufacturing environment that continues to evolve autonomously.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments for carrying out the present invention will be described more specifically and with more depth. The factory robot autonomous safety and quality optimization system of the present invention is composed of a server, a terminal at the site, various IoT sensors, a robot control device, a network infrastructure, a user interface device, and the like. The server is responsible for core processing of generative AI, and the terminal at the site is responsible for edge processing and interaction with a worker at the site. Various IoT sensors are installed on a robot main body and peripheral equipment, and acquire a wide variety of data in real time. Specifically, the factory robot autonomous safety and quality optimization system implements a hybrid computing architecture of cloud and edge. The system receives a multidimensional state vector including an angle, an angular velocity, and a motor torque of each joint acquired from the robot control device as input data. The system simultaneously receives an environmental vector indicating temperature and humidity of a peripheral environment as input. An edge terminal of the system executes preprocessing of applying a Kalman filter to the input data, removing sensor noise, and estimating a true state. The system executes a lightweight abnormality detection neural network on an edge side, and performs real-time inference in units of milliseconds. The system executes a large-scale trajectory optimization transformer model on a cloud side, and formulates a long-term operation plan. The system combines inference results of both by an integration module. The system generates a vector of a correction torque command value for each joint of the robot as output data. The system simultaneously outputs a target coordinate matrix for correcting an operation trajectory of the robot. The system directly transmits the command value vector to a servo amplifier of the robot via a real-time communication protocol. The system writes the target coordinate matrix into a memory area of a robot controller. In a learning process of the system, the system executes batch learning using large-scale operation data collected on the cloud side. The system executes online learning using a latest error signal on the edge side, and fine-tunes a weight of the model. The system realizes advanced autonomous control while minimizing an influence of communication delay by this hierarchical processing architecture. The system achieves both enormous computing power of the cloud and responsiveness of the edge. The system brings about a technical effect of maximizing operation accuracy and safety of the robot. The system is applied to a cell production line where a human and a robot collaborate in the same space, an assembly process of a precision part requiring accuracy in units of millimeters, and the like. The system converts an analog signal acquired from various IoT sensors into a digital signal at high speed using a field programmable gate array in the edge terminal. The system packetizes the converted data together with a time stamp, and transmits the packetized data to the server through a network infrastructure compliant with a time-sensitive networking standard. The system guarantees an arrival delay of a packet on the order of microseconds. The system adopts an augmented reality headset having a spatial mapping function as a user interface device. The system renders a predicted trajectory vector of the robot calculated by the server as a three-dimensional virtual object. The system transmits rendering data to the headset, and superimposes and displays the rendering data in a real space within a visual field of the worker. The system enables the worker to intuitively predict a next movement of the robot, and prevents a contact accident.

The robot state monitoring unit installs a temperature sensor, a vibration sensor, a torque sensor, a current sensor, an acceleration sensor, a pressure sensor, a humidity sensor, a load sensor, an image acquisition camera, an acoustic sensor, an infrared sensor, a proximity sensor, an encoder, and the like in a main component part of each robot, such as an arm part of a welding robot, a joint part of an assembly robot, a drive wheel of a transfer robot, a nozzle of a coating robot, a camera head of an inspection robot, a gripper of a palletizing robot, a spindle of a polishing robot, and a suction pad of a picking robot, and collects data at a high frequency in units of milliseconds. For example, the robot state monitoring unit detects any sign of abnormality in real time, such as when an arm temperature of the welding robot rapidly rises, when vibration of the joint part of the assembly robot becomes larger than usual, when a torque of the drive wheel of the transfer robot abnormally fluctuates, when a nozzle pressure of the coating robot decreases, when noise or distortion occurs in a camera image of the inspection robot, when a gripper load of the palletizing robot becomes unstable, when a spindle rotation speed of the polishing robot wildly fluctuates, and when a vacuum pressure of the suction pad of the picking robot decreases. In the terminal at the site, these data are temporarily buffered, subjected to preprocessing such as noise removal, abnormal value correction, time synchronization, data compression, and feature amount extraction, and transmitted to the server. In the server, the generative AI integrally analyzes multidimensional data such as a time-series fluctuation pattern of temperature, a frequency spectrum of vibration, a peak value and a fluctuation range of torque, edge detection and a color histogram of an image, spectrogram analysis of sound, minute fluctuation of pressure, distribution of load, and an abnormal pattern of acceleration, and automatically detects an abnormal value or an abnormal tendency. For example, when an abnormality is detected, such as when a state in which the arm temperature of the welding robot is 10 degrees or more higher than usual continues, when the vibration of the joint part of the assembly robot rapidly increases in a specific frequency band, when the drive wheel torque of the transfer robot repeats rapid increase and decrease at a constant cycle, when the nozzle pressure of the coating robot largely fluctuates in a short time, and when periodic distortion appears in the camera image of the inspection robot, an immediate alert is issued to a terminal of a person in charge at the site or a manager, and data before and after the occurrence of the abnormality, related sensor data, an operation log of the robot, a work instruction history, and the like are automatically recorded and saved. Specifically, the robot state monitoring unit implements a hybrid model of a one-dimensional convolutional neural network and a recurrent neural network. The model receives a high-frequency time-series array acquired in units of milliseconds from an encoder or a torque sensor of each joint as input data. The system temporarily holds data using a ring buffer memory in the terminal at the site. The system executes preprocessing of removing high-frequency noise using wavelet transform and compressing a dimension of data by principal component analysis. A convolutional layer of the network extracts a local feature pattern of minute abnormal vibration or torque fluctuation from the compressed time-series data. A recurrent layer of the network models a time-series state transition of the extracted feature using a long short-term memory cell. The model generates a continuous value score from zero to one indicating a degree of abnormality of each robot part as output data. The model simultaneously outputs a one-hot vector classifying a type of abnormality. The system determines whether or not the abnormality degree score exceeds a threshold value set as a safety standard. When the threshold value is exceeded, the system generates a hardware interrupt signal and immediately cuts off power supply to the servo amplifier of the robot. The system simultaneously flash-writes all sensor data for ten seconds before and after the occurrence of the abnormality to a database on the server. In a learning process of the model, the system executes semi-supervised learning by an autoencoder using only data during normal operation. The system updates a weight so as to minimize a reconstruction error of input data as a loss function. The system instantaneously detects a minute mechanical abnormality at a level that cannot be sensed by a human by this combination of high-frequency sampling and deep learning. The system brings about a technical effect of preventing a serious collision accident or fatal damage to an expensive robot part. The system is applied to equipment having large kinetic energy and causing enormous damage in the event of an accident, such as an articulated robot drawing a high-speed and complex trajectory and a palletizing robot handling a heavy object. The system executes optical flow analysis on a video stream from the image acquisition camera. The system calculates a deviation vector between an actual operation trajectory of the robot and a control command value. The system performs multimodal abnormality detection by combining the deviation vector with a time-series feature amount. The system inputs the one-hot vector indicating the type of abnormality to a natural language generation model when an alert is issued. The system generates specific instruction text such as “Abnormal vibration detected in reduction gear of third joint. Stop line immediately and perform visual inspection.” The system push-notifies the generated text to a smart watch of the manager. The system executes these processes on a dedicated AI chip in the edge terminal, and suppresses inference latency to within several milliseconds.

The predictive maintenance unit accumulates and analyzes time-series data obtained from the robot state monitoring unit over a long period of time using generative AI, and predicts a deterioration tendency or a sign of failure or deterioration of a machine for each equipment with high accuracy. For example, the predictive maintenance unit detects wear of an arm bearing of a welding robot from a harmonic component or amplitude increase of vibration data, detects gear wear of a drive unit of an assembly robot from abnormal fluctuation of a torque value or a current value, predicts brush wear or gear wear of a motor of a transfer robot by composite analysis of temperature, current, and acceleration data, detects nozzle clogging or seal deterioration of a coating robot from pressure, flow rate, and image data, estimates calibration deviation of a camera or a sensor of an inspection robot from image and position data, detects wear or pneumatic abnormality of a gripper of a palletizing robot from load, pressure, and an operation pattern, predicts tool wear or spindle bearing deterioration of a polishing robot from vibration, torque, and rotation speed data, and estimates wear of a suction pad or vacuum pump deterioration of a picking robot from pressure, flow rate, and an operation log. The generative AI estimates a failure probability or a remaining life for each equipment by combining, for example, a past failure history, a maintenance history, a part replacement history, an operation time, a load history, and environmental conditions (temperature, humidity, dust concentration, etc.), and automatically notifies a terminal of a person in charge at the site or a person in charge of maintenance from the server of a specific prediction result such as “failure risk of arm of welding robot increases within remaining 100 hours of operation”, “maintenance of drive unit of assembly robot is recommended within one week”, “replacement of motor of transfer robot is recommended at next periodic inspection”, and “doubling of cleaning frequency of nozzle of coating robot is recommended”. Furthermore, data of the same type of robot at a plurality of locations or a plurality of lines can be cross-sectionally analyzed and utilized for optimization of a company-wide maintenance plan and efficiency improvement of part inventory management. Specifically, the predictive maintenance unit implements a probabilistic prediction model combining Gaussian process regression and a deep belief network. The model receives a multidimensional feature amount vector including a cumulative operation time of the robot, a past maintenance history, and a current environmental temperature as input data. The system executes preprocessing of applying an exponential smoothing method to the input data, removing sudden noise, and extracting a trend component of deterioration. A deep belief network part of the network has a structure in which restricted Boltzmann machines are stacked in a plurality of layers. The network hierarchically extracts a feature of a non-linear deterioration mechanism. A Gaussian process regression part of the network models transition of a deterioration curve as a probability distribution using the extracted feature amount. The model generates a continuous value vector indicating a predicted value of a remaining life of each consumable part as output data. The model simultaneously outputs a variance matrix indicating uncertainty of the prediction. The system formulates an optimal part replacement schedule based on the predicted value vector. The system writes the formulated schedule into a maintenance management database, and overwrites and updates an existing plan. When a diagonal component of the variance matrix exceeds a certain threshold value, the system determines that reliability of prediction is low, and sets a flag requesting additional sensor calibration. In a learning process of the model, the system estimates a posterior probability distribution using a Markov chain Monte Carlo method. The system optimizes a hyperparameter so as to minimize a prediction error using wear amount data at the time of actual part replacement as a teacher signal. The system realizes highly accurate life prediction considering an individual difference for each part or a difference in operation environment, which is impossible by simple threshold determination, by this probabilistic deterioration modeling. The system enables condition-based maintenance that uses up a life of a part to a limit. The system brings about a technical effect of reducing excessive periodic replacement and significantly reducing a maintenance cost. The system is applied to equipment having a large opportunity loss of maintenance, such as a semiconductor transfer robot operating in a clean room and a take-out robot of a die casting machine operating in a harsh environment. The system integrates feature amount vectors collected from the same type of robot at a plurality of locations, and constructs a global deterioration model using federated learning. The system shares a rare failure pattern occurring only at a specific location across the entire company, and raises prediction accuracy. The system compares and calculates the predicted remaining life and a procurement lead time of a part. When detecting a risk that the lead time exceeds the remaining life, the system calls an application programming interface of a purchasing system and executes automatic ordering processing. The system generates text “Motor brush for transfer robot of second line, 15 days remaining until reaching predicted life. Urgently ordered due to out of stock” using a generative language model. The system highlights and displays the generated text on a dashboard of the person in charge of maintenance. The system periodically executes these complex statistical calculations in batches in a tensor processing unit cluster on the cloud.

The automatic quality management unit multilaterally analyzes quality inspection data, a product image, and various sensor data of work performed by each robot using generative AI, and automatically detects a defective product or a quality abnormality with high accuracy. For example, the automatic quality management unit detects a minute crack or poor welding from a welding bead image of a welding robot, determines poor tightening or an assembly error of a part from a tightening torque or position data of an assembly robot, detects coating unevenness or foreign matter adhesion from a coated surface image of a coating robot, detects dropping of a part or a transfer error from a load sensor or image data of a transfer robot, determines a dimensional abnormality or poor appearance by image recognition of an inspection robot, detects a loading error or a load collapse risk from a loading state image of a palletizing robot, detects poor polishing or tool wear from a surface finish image or vibration data of a polishing robot, and determines a gripping error or part damage from a gripper pressure or position data of a picking robot. For example, the welding robot performs image analysis on a width and a height of a welding bead, presence or absence of a crack, a color tone change of a welded part, and the like, the assembly robot detects time-series fluctuation of a tightening torque or deviation of a tightening position, the coating robot performs image analysis on color unevenness, coating thickness, and foreign matter adhesion of a coated surface, the transfer robot detects rapid fluctuation of a load sensor or part position deviation on an image, the inspection robot determines out-of-dimensional tolerance or an appearance scratch by image recognition, the palletizing robot detects a load collapse risk or a loading pattern abnormality from a loading image, the polishing robot determines surface roughness or tool wear from image and vibration data, and the picking robot detects an abnormality in gripping pressure or suction pressure. When a defective product or a quality abnormality is detected, a corresponding product is removed or marked from a line, an inspection result and defective product data are centrally managed by a server and displayed in real time to a worker on a terminal at the site, and the worker can also perform re-inspection or correction work on the spot. Specifically, the automatic quality management unit implements an architecture integrating an instance segmentation model and a multivariate time-series classification model. The model receives a high-resolution image tensor acquired from a camera mounted on an end effector of the robot as input data. The model simultaneously receives a time-series array of torque or pressure acquired from a controller of the robot as input. The system executes preprocessing of applying histogram equalization to image data and correcting fluctuation of an illumination condition. An image processing module of the network generates feature maps of different scales using a feature pyramid network. The network individually extracts a feature of each part or welding bead in an image using region of interest pooling. A time-series processing module of the network extracts a feature of a peak value or a fluctuation cycle from a torque waveform using a one-dimensional convolutional layer. The model generates polygon coordinate data indicating an outline of each part in the image as output data. The model simultaneously outputs a probability distribution vector indicating a quality class of each part. The system measures a dimension of a part or a width of a welding bead in units of pixels based on polygon coordinates. The system converts a measurement value into a physical millimeter unit using an internal parameter of the camera, and compares and calculates it with a design tolerance. When the measurement value is out of tolerance, or when an abnormality probability of the quality class exceeds a threshold value, the system transmits a command vector instructing a reject operation to the control device of the robot. The system links an image of a defective product and sensor data and saves them in a quality management database. In a learning process of the model, the system executes supervised learning using a large number of defect images. The system artificially generates an image of a rare defect pattern using a generative adversarial network, and performs data augmentation. The system minimizes a sum of a cross entropy error and a regression error of a bounding box as a loss function. The system simultaneously executes highly accurate dimension measurement and appearance inspection even for a part having a complex shape by fusion of this pixel-level precise image analysis and physical sensor data. The system brings about a technical effect of achieving accuracy exceeding a limit of human visual inspection and significantly shortening a tact time of an inspection process. The system is applied to a manufacturing site requiring an extremely high quality standard, such as a vehicle body welding line of an automobile and a fine housing assembly process of a smartphone. The system transmits polygon coordinate data of a detected defect to a display of the terminal at the site. The system executes overlay drawing for highlighting a defective part on a screen of the worker. The system acquires coordinate data of correction completion input by the worker through a touch panel of the terminal. The system inputs a corrected image to the model again, and automatically re-evaluates whether a quality standard is satisfied. The system executes these inference processes on an edge AI computer installed near the robot. The system realizes in-line total inspection completely synchronized with an operation cycle of the robot without being affected by network delay.

The data integrated analysis and improvement proposal unit integrally analyzes all data collected from the robot state monitoring unit, the predictive maintenance unit, and the automatic quality management unit by generative AI on a server, extracts a tendency or a problem for each robot or each process, and automatically generates a specific improvement measure. For example, the generative AI analyzes multidimensional data such as a past incident log, a quality inspection result, a maintenance history, an equipment operation status, an operation history of a worker, productivity data for each process, energy consumption data, raw material lot information, external environment data (temperature, humidity, atmospheric pressure, etc.), design information from an equipment manufacturer, traceability information from a part supplier, and weather and supply-demand data from an external cloud service, and automatically generates an improvement proposal optimized for each site, each location, or across the entire company, such as “necessity of addition of a cooling fan of a welding robot”, “effectiveness of readjustment of an operation parameter of an assembly robot”, “necessity of increasing a nozzle cleaning frequency of a coating robot”, “route optimization of a transfer robot”, “shortening of a camera calibration cycle of an inspection robot”, “standardization of a loading procedure of a palletizing robot”, “optimization of a tool replacement timing of a polishing robot”, “adjustment of a gripping force of a picking robot”, “reinforcement of a worker education program”, “process reorganization for improving an operation rate of equipment”, and “operation pattern optimization for reducing energy consumption”. It is also possible to personalize a content of the proposal in consideration of a past response history and a degree of understanding of a person in charge at the site, and a proposal conforming to an actual situation of the site is made, such as attaching a detailed procedure manual or a video manual to an inexperienced worker and notifying only main points to an expert. Specifically, the data integrated analysis and improvement proposal unit implements a large language model architecture integrating a causal inference model and a knowledge graph embedding model. The model receives a heterogeneous mixed data set including an operation log of a robot, a quality inspection result, and external weather data as input data. The system executes preprocessing of extracting an entity and a relation from an unstructured text log using a natural language processing technology. The system combines the extracted information with structured data, and constructs a huge knowledge graph. The network embeds each node and edge of the knowledge graph in a low-dimensional continuous vector space using a graph neural network. The network quantitatively estimates a causal effect between a specific intervention variable and an observation variable using a causal inference algorithm. The model inputs an embedding vector and an estimated value of a causal effect as a context to a decoder part of a language model. The model generates path data between nodes indicating a root cause of productivity decline as output data. The model simultaneously outputs natural language text describing a specific improvement measure for solving the cause. The system outputs the path data to a graph visualization tool, and renders it as a network diagram on a manager dashboard. The system collates the generated text with a profile vector indicating a skill level of the person in charge at the site. The system automatically inserts a uniform resource locator of a video manual into text for an inexperienced worker. The system executes personalization processing of summarizing into concise bulleted text using a technical term for an expert. The system automatically transmits final text through an application programming interface of an e-mail or a chat application. In a learning process of the model, the system optimizes a graph representation by self-supervised learning using a link prediction task. The system applies reinforcement learning using a success/failure history of an improvement measure implemented in the past as a reward signal to the language model. The system identifies an intervention action that is actually effective, not limited to presentation of a mere correlation, by this advanced modeling of a causal relationship. The system integrates siloed data in a factory, and unravels intertwining of complex factors that a human does not notice. The system brings about a technical effect of creating innovative process improvement and fundamentally raising company-wide production efficiency. The system is applied to a large-scale automobile assembly factory where hundreds of robots operate in cooperation, an electronic device manufacturer susceptible to fluctuation of a supply chain, and the like. The system inputs a time-series prediction vector of power supply and demand data acquired from an external cloud service to the causal inference model. The system predicts a time zone when a power rate soars, and calculates an operation pattern optimization parameter for automatically shifting operation of a robot with large energy consumption. The system transmits the calculated parameter to a manufacturing execution system, and dynamically changes a production plan. The system efficiently executes these enormous graph calculations and text generation processing using a distributed database and a parallel computing cluster on a cloud.

The user interface unit provides a screen or a dashboard on which a worker at the site or a manager can operate and confirm various functions of the system, and enables immediate display of an alert notification, browsing of detailed data when an abnormality occurs, confirmation of a maintenance recommendation, list display of a quality inspection result, reception of an improvement proposal, input of feedback from the site, browsing of a work procedure manual or a video manual, reference to a past response history, and the like. The terminal at the site can be configured in various forms such as a smartphone, a tablet, a wearable terminal, an industrial PC, and AR glasses, and the worker at the site can immediately confirm an alert or an improvement proposal and input a response status or a work result on the spot. Specifically, the user interface unit implements a spatial computing algorithm and an eye-tracking neural network. The model receives a stereo video tensor acquired from a front camera of augmented reality glasses as input data. The model simultaneously receives a coordinate vector indicating an eye movement of a user acquired from an infrared sensor inside the glasses as input. The system executes preprocessing of applying self-position estimation and a mapping algorithm to the video tensor, and grasping a three-dimensional structure of a real space as point cloud data. The network extracts a center coordinate of a pupil from an eyeball image using a convolutional layer. The network calculates a three-dimensional line-of-sight vector of the user from the extracted coordinate. The system geometrically calculates an intersection between the line-of-sight vector and a three-dimensional structure model of the real space, and specifies a physical coordinate of an object currently gazed at by the user. The model generates rendering data of a virtual object including sensor data or improvement proposal text related to a gaze target as output data. The model simultaneously outputs a transformation matrix for arranging the virtual object at a correct position in the real space. The system performs coordinate transformation on the rendering data using the transformation matrix, and projects it onto a transmissive display of the augmented reality glasses. The system superimposes and displays a virtual instrument panel or warning mark on an actual robot or equipment. The system recognizes a hand gesture performed in the air by the user from a camera video by a skeleton estimation model. The system converts the recognized gesture into an input command vector to the system. When detecting an operation in which the user “presses” a virtual button, the system transmits a completion flag of a response status to a database of the server. In a learning process of the model, the system executes reinforcement learning using an operation history of the user and a time until task completion as a reward function. The system updates a policy network so as to optimize a timing, a position, and an information amount of information presentation. The system provides necessary information in real time without occupying both hands of the worker by this intuitive spatial interface. The system eliminates a useless operation of moving a line of sight or changing a terminal. The system brings about a technical effect of dramatically reducing a work error and dramatically improving work efficiency of maintenance or setup change. The system is applied to an assembly site of an aircraft accompanied by complex wiring work, a manufacturing facility of a biopharmaceutical in which contact with equipment is restricted to maintain an aseptic state, and the like. The system decodes high-resolution video manual data received from the server in the edge terminal. The system synchronizes a playback frame of a video with a work progress of the user. The system executes a control logic of determining a state of a part at hand of the user using an image recognition model, and playing a next video frame after confirming that a correct procedure is completed. The system executes these advanced image processing and rendering on a low power consumption system-on-chip in a wearable terminal. The system provides an immersive user experience without delay while securing a battery drive time.

The data accumulation unit integrally saves all sensor data, image data, acoustic data, an inspection result, an incident log, a maintenance history, a work history, an improvement proposal history, and the like in time series, and utilizes them for future retraining of an AI model, detailed analysis by a human, an audit response, ensuring traceability, and the like. Specifically, the present data accumulation unit implements a data lake architecture integrating a distributed column-oriented database and a high-dimensional vector search engine. The present system receives a continuous stream of structured data and unstructured data generated from all systems in a factory as input data. The present system performs schema validation on the structured data and executes preprocessing of filtering a missing value or an abnormal value. The present system inputs an image or text which is unstructured data to a deep learning-based encoder model. The present network uses a residual network for an image, for example, and uses a transformer for text, and converts each data into a fixed-length dense feature vector. The present system compresses the structured data into a column-oriented format and writes to a distributed file system using a time stamp as a primary key. The present system stores the converted feature vector in a vector database as output data. At the same time, the present system constructs an index using a hierarchical navigable small world algorithm for each vector. The present system executes an approximate nearest neighbor search for a search query vector input from a user or an analysis module. The present system generates a list of past incident cases or image data most similar to the query as output data. The present system returns a data set of a search result to a request source via an application programming interface. In a learning process of the present system, the present system periodically fine-tunes the encoder model using a contrastive learning method. The present system optimizes a weight of the network so that data of different incidents occurring due to the same cause are close to each other on a vector space and unrelated data are kept away from each other. By this advanced indexing and distributed storage technology, the present system realizes a high-speed similarity search in milliseconds for petabyte-class enormous multimodal data. The present system instantaneously extracts an enormous amount of past experience data and makes it applicable to solving a current unknown trouble. The present system brings about a technical effect of strongly supporting rapid cause investigation and data-driven decision making. The present system is applied to an aerospace industry in which a product life cycle is long and traceability over several decades is required, or a pharmaceutical industry subject to a strict regulatory authority audit. The present system automatically applies a data life cycle management policy to the saved data. The present system asynchronously migrates old data with a decreased access frequency to an inexpensive cold storage tier. The present system optimizes a storage cost. For an audit response, the present system generates a hash chain using blockchain technology at the time of writing data. The present system mathematically proves that falsification of data is physically impossible. The present system load-balances these data processing pipelines to a plurality of storage nodes using a distributed hash table. The present system constructs an extremely robust data infrastructure without a single point of failure.

The communication control unit controls data transmission and reception between a terminal at the site and a server, between a plurality of locations, and with an external system, and responds to various communication protocols and security requirements, for example, real-time transfer of sensor data, immediate distribution of an alert notification, batch transmission of image data, cooperation with an external cloud service, information cooperation with an equipment manufacturer or a parts supplier, acquisition of weather data or power supply and demand data, and the like. Specifically, the present communication control unit implements a software-defined network and a machine learning-based traffic prediction model. The present model receives a traffic state vector including a packet arrival rate, a delay time, and a packet loss rate acquired from a network switch as input data. The present system calculates a moving average for the input data and executes preprocessing of smoothing a minute fluctuation. The present network predicts a future network load from a past traffic fluctuation pattern using a long short-term memory network. The present network dynamically calculates a priority of each data flow and an optimal routing path based on a prediction result. The present model generates an update command vector of a routing table for each network device as output data. The present model simultaneously outputs a parameter value of bandwidth limitation or queuing. The present system transmits the update command to each switch or router using an OpenFlow protocol. The present system changes a logical topology in real time without changing a physical configuration of the network. For mission-critical data such as an emergency stop signal or an alert notification, the present system allocates a dedicated low-delay queue and transfers the data with the highest priority. For large-capacity image data or backup data, the present system schedules batch transmission to be performed in a time zone when the network is free. In a learning process of the present model, the present system executes supervised learning using a past traffic log and a packet loss occurrence history. The present system updates a weight of the network so as to improve prediction accuracy using a mean square error as a loss function. By this intelligent bandwidth control and dynamic routing, the present system completely avoids network congestion even for a sudden increase in data communication amount. The present system achieves both real-time property of control data and reliable transfer of large-capacity data. The present system brings about a technical effect of preventing a malfunction of a robot or a system down due to a communication delay. The present system is applied to an environment where stability of communication is directly linked to safety, such as a huge smart factory to which tens of thousands of IoT devices are connected, or an unmanned construction site where heavy machinery is operated from a remote location. In cooperation with an external system, the present system functions as a gateway of an application programming interface. The present system analyzes a payload of weather data or power supply and demand data received from the outside and converts the payload into a tensor of a standard format processable by an internal system. At the time of data transmission to the outside, the present system encrypts a communication path using a transport layer security protocol. The present system further applies an advanced encryption standard algorithm to the data itself to ensure double security. The present system executes these traffic control processes at wire speed on a dedicated network processor. The present system does not cause any overhead in packet transfer processing.

As described above, the factory robot autonomous safety and quality optimization system of the present invention highly automates and optimizes all functions of real-time monitoring, predictive maintenance, automatic quality management, and data analysis and improvement proposal by the generative AI for all robots, processes, equipment, and locations at the site, and safety, quality, and efficiency at the site can be dramatically improved. Further, it is flexibly applicable to various industries, processes, equipment, and locations at the site, and future expansion and cooperation with other systems are easy, so that it becomes a system with extremely high practicality, expandability, and competitiveness. Specifically, the present factory robot autonomous safety and quality optimization system implements an autonomous distributed multi-agent system and a federated learning architecture. The present system receives a local optimization index vector transmitted from an agent of each factory location as input data. This input vector is multidimensional numerical data including production efficiency, energy consumption, and a quality score of each location. Instead of collecting raw data from each location, the present system executes preprocessing of receiving only a gradient vector of a neural network calculated on an edge side. The present network searches for a global optimal solution that maximizes company-wide profit using a consensus building algorithm based on game theory. The present network executes multi-agent reinforcement learning in which each agent updates its own policy while considering a state of another location. The present model generates a continuous value vector indicating an adjustment value of a production plan for each location as output data. The present model simultaneously outputs a weight parameter matrix of an integrated global model. The present system transmits the adjustment value vector to a manufacturing execution system of each location and synchronously controls company-wide production activities. The present system distributes the updated weight parameter to all edge devices and synchronizes a local model. In a learning process of the present system, the present system uses a secure multi-party computation technology to mathematically prevent original data from being restored from the gradient vector. The present system realizes sophistication of a model using company-wide data while completely protecting confidential information of each location. By this scalable distributed architecture, the present system autonomously optimizes an entire global supply chain, not limited to optimization of a single factory. Even when a new robot or production line is added, the present system integrates it into the system by plug and play and immediately makes it participate in a learning network. The present system fundamentally strengthens competitiveness of a company and exhibits a technical effect of bringing about overwhelming adaptability to a rapidly changing market environment. The present system is applied to a global manufacturing company that integrally manages production locations distributed all over the world, or a consortium-type manufacturing network that shares quality data among a plurality of supplier companies. The present system cooperates with an external enterprise resource planning system or customer relationship management system through a standardized application programming interface. The present system directly inputs a demand prediction vector of a market to an optimization algorithm of a production plan. The present system seamlessly couples all processes from a customer order to manufacturing and shipping in a data-driven manner. The present system executes these complex distributed processes on a cloud-native container orchestration infrastructure. The present system constructs a next-generation intelligent manufacturing platform having infinite expandability and extremely high fault tolerance.

### (System Configuration)

The system according to the present embodiment comprises a robot state monitoring unit, a predictive maintenance unit, an automatic quality management unit, a data integrated analysis and improvement proposal unit, a user interface unit, a data accumulation unit, and a communication control unit. The robot state monitoring unit acquires data in real time in milliseconds from a temperature sensor, a vibration sensor, a torque sensor, a current sensor, an acceleration sensor, a pressure sensor, a humidity sensor, a load sensor, an image acquisition camera, an acoustic sensor, an infrared sensor, a proximity sensor, an encoder, and the like installed in various robots such as a welding robot, an assembly robot, a transfer robot, a painting robot, an inspection robot, a palletizing robot, a polishing robot, and a picking robot in a factory, performs preprocessing such as noise removal, abnormal value correction, time synchronization, data compression, and feature amount extraction at a terminal at the site, and then transmits the data to a server, and the generative AI on the server integrally analyzes multidimensional data such as time-series fluctuation of temperature, a frequency spectrum of vibration, a peak value and a fluctuation range of torque, edge detection and a color histogram of an image, spectrogram analysis of sound, minute fluctuation of pressure, distribution of load, and an abnormal pattern of acceleration, automatically detects an abnormal value or an abnormal tendency, for example, when an arm temperature of the welding robot rapidly rises, when vibration of a joint part of the assembly robot rapidly increases in a specific frequency band, when a drive wheel torque of the transfer robot periodically repeats rapid increase and decrease, when a nozzle pressure of the painting robot largely fluctuates in a short time, or when periodic distortion appears in a camera image of the inspection robot, issues an immediate alert to a terminal of a person in charge at the site or a manager, and automatically records and saves data before and after the occurrence of the abnormality, related sensor data, an operation log of the robot, a work instruction history, and the like. Specifically, the present system operates on a distributed processing cluster composed of a plurality of calculation nodes. The present robot state monitoring unit converts an analog signal acquired from each sensor into a digital time-series array via an analog-to-digital converter. The present terminal at the site executes noise removal processing using a Kalman filter on the acquired digital time-series array. The present terminal at the site applies a fast Fourier transform to the data after noise removal. The present terminal at the site converts time domain data into frequency domain data. The present terminal at the site extracts a power spectral density of a specific frequency band from the converted frequency domain data as a feature vector. The present terminal at the site transmits the extracted feature vector to the server together with a time stamp. The present server expands the received feature vector as a multidimensional tensor on a memory. The present server implements a composite neural network including a large language model and a transformer model for time-series analysis. The present composite neural network comprises an input layer, a plurality of self-attention mechanism layers, and an output layer. The present server inputs the multidimensional tensor to the input layer of the present composite neural network. The input data includes, for example, a 128-dimensional vibration feature vector, a 64-dimensional temperature time-series array, and a 256-dimensional image feature tensor. The present composite neural network calculates a hidden correlation between respective sensor data on a high-dimensional space using a self-attention mechanism. The present composite neural network outputs an abnormality probability score and a classification label of an abnormality factor from the output layer. The output data includes, for example, an abnormality probability score ranging from zero to one, a one-hot vector indicating an abnormal part, and a class label indicating severity of the abnormality. The present server determines whether or not the output abnormality probability score exceeds a preset threshold value. The present server generates an abnormality detection flag when the threshold value is exceeded. The present server transmits an alert signal to a manager terminal via the communication control unit using the abnormality detection flag as a trigger. The present server saves a raw data array for 500 milliseconds before and after the occurrence of the abnormality in a database together with the alert signal. By this processing, the present system detects a sign of a minute abnormality that cannot be found by human visual inspection or simple threshold determination in real time. The present system exhibits a technical effect of preventing a sudden stop of equipment. The present system is extremely useful in a use case where advanced automation is required, such as an automobile manufacturing line or a semiconductor manufacturing factory.

The predictive maintenance unit accumulates and analyzes time-series data obtained from the robot state monitoring unit over a long period of time using the generative AI, and predicts a deterioration tendency or a sign of failure or deterioration of a machine for each equipment with high accuracy. For example, it detects wear of an arm bearing of the welding robot from a harmonic component or an amplitude increase of vibration data, detects gear wear of a drive unit of the assembly robot from an abnormal fluctuation of a torque value or a current value, predicts brush wear or gear wear of a motor of the transfer robot by composite analysis of temperature, current, and acceleration data, detects nozzle clogging or seal deterioration of the painting robot from pressure, flow rate, and image data, estimates a calibration deviation of a camera or a sensor of the inspection robot from image and position data, detects wear or a pneumatic abnormality of a gripper of the palletizing robot from load, pressure, and an operation pattern, predicts tool wear or spindle bearing deterioration of the polishing robot from vibration, torque, and rotation speed data, and estimates wear of a suction pad or vacuum pump deterioration of the picking robot from pressure, flow rate, and an operation log. The generative AI also combines a past failure history, a maintenance history, a parts replacement history, an operation time, a load history, an environmental condition, and the like, estimates a failure probability or a remaining life for each equipment, automatically notifies a specific prediction result such as “a failure risk of the arm of the welding robot increases within the remaining 100 hours of operation”, “maintenance of the drive unit of the assembly robot is recommended within one week”, “replacement of the motor of the transfer robot is recommended at the next periodic inspection”, or “doubling a cleaning frequency of the nozzle of the painting robot is recommended” from the server to a terminal of a person in charge at the site or a person in charge of maintenance, cross-sectionally analyzes data of the same type of robots at a plurality of locations or a plurality of lines, and utilizes the data for optimization of a company-wide maintenance plan or efficiency improvement of parts inventory management. Specifically, the present predictive maintenance unit adopts a hybrid neural network architecture combining a long short-term memory network and a transformer model. The present predictive maintenance unit reads a time-series transition of sensor data over the past several months as a multidimensional matrix from a database. The present predictive maintenance unit executes normalization processing on the read multidimensional matrix. The present predictive maintenance unit supplies the normalized multidimensional matrix to an input layer of the hybrid neural network. The input data includes, for example, a moving average vector of a current value for the past 10,000 hours, a peak frequency transition array of vibration, and a time-series tensor of a temperature rise rate. The present hybrid neural network extracts a long-term dependency of time-series data in a long short-term memory network layer. The present hybrid neural network calculates an interaction between different sensor data as an attention weight in a transformer layer. The present hybrid neural network outputs a continuous value indicating a remaining life of each part and a probability distribution of a failure probability from an output layer. The output data includes, for example, a predicted time numerical value indicating a remaining life, a softmax probability value for three types of failure modes, and a variance value indicating a confidence interval of prediction. The present predictive maintenance unit determines whether or not the output remaining life falls below a specified safety margin. The present predictive maintenance unit generates a maintenance recommendation flag when it falls below the safety margin. The present predictive maintenance unit calculates an optimal timing of parts replacement based on the maintenance recommendation flag. The present predictive maintenance unit automatically transmits the calculated timing information to a maintenance management system. The present hybrid neural network optimizes a weight parameter by supervised learning based on past failure record data using a loss function combining a mean square error function and a cross entropy error function. By this processing, the present system models a complex deterioration mechanism as a non-linear function instead of a mere threshold excess. The present system exhibits a technical effect of predicting a life of a part with extremely high accuracy and reducing excessive maintenance. The present system is particularly effective in a use case where downtime causes enormous economic loss, such as a manufacturing line of aircraft parts or a large-scale chemical plant.

The automatic quality management unit multilaterally analyzes quality inspection data, a product image, and various sensor data of work performed by each robot using the generative AI, and automatically detects a defective product or a quality abnormality with high accuracy. For example, it detects a minute crack or poor welding from a weld bead image of the welding robot, determines poor tightening or an assembly error of a part from a tightening torque or position data of the assembly robot, detects coating unevenness or foreign matter adhesion from a coated surface image of the painting robot, detects dropping of a part or a transfer error from a load sensor or image data of the transfer robot, determines a dimensional abnormality or an appearance defect by image recognition of the inspection robot, detects a loading error or a load collapse risk from a loading state image of the palletizing robot, detects poor polishing or tool wear from a surface finish image or vibration data of the polishing robot, and determines a gripping error or part damage from a gripper pressure or position data of the picking robot. When a defective product or a quality abnormality is detected, the corresponding product is removed or marked from the line, an inspection result or defective product data is integrally managed by the server, and is displayed in real time to a worker on a terminal at the site, and the worker can also perform re-inspection or correction work on the spot. Specifically, the present automatic quality management unit implements an image analysis model integrating a convolutional neural network and a visual transformer. The present automatic quality management unit reads RGB image data of a product acquired from a high-resolution camera into a memory as a three-dimensional tensor. The present automatic quality management unit executes preprocessing of contrast enhancement and edge extraction on the three-dimensional tensor. The present automatic quality management unit inputs the three-dimensional tensor after preprocessing to an input layer of the image analysis model. The input data includes, for example, a three-channel image tensor having a resolution of 1024 pixels square, and a one-dimensional array indicating a current-voltage waveform during welding. The present image analysis model generates a local feature map of an image via a plurality of convolutional layers and pooling layers. The present image analysis model calculates a global relationship between patches of the feature map in a visual transformer layer. The present image analysis model outputs bounding box coordinates of a defect and a classification score of a defect type from an output layer. The output data includes, for example, four coordinate values indicating a defect position, a probability value for each defect class such as a crack or a bubble, and a scalar value indicating a non-defective product probability. The present automatic quality management unit determines whether or not the output non-defective product probability falls below a specified quality reference value. The present automatic quality management unit generates a defective product determination flag when it falls below the quality reference value. The present automatic quality management unit transmits the defective product determination flag to a programmable logic controller. The present programmable logic controller drives a discharge mechanism based on the received flag, and physically excludes the corresponding product from the manufacturing line. The present image analysis model is pre-learned using a pseudo defective product image generated by a data augmentation method using a generative adversarial network. By this processing, the present system accurately identifies a minute defect that is easily overlooked by human visual inspection in units of pixels. The present system exhibits a technical effect of realizing complete automation of an inspection process and uniformization of quality. The present system is an indispensable configuration in a use case where an extremely high quality standard is required, such as a mounting process of an electronic board or a manufacturing line of a precision medical device.

The data integrated analysis and improvement proposal unit integrally analyzes all data collected from the robot state monitoring unit, the predictive maintenance unit, and the automatic quality management unit on the server using the generative AI, extracts a tendency or a problem for each robot or each process, and automatically generates a specific improvement measure. For example, the generative AI analyzes multidimensional data such as a past incident log, a quality inspection result, a maintenance history, an equipment operation status, an operation history of a worker, productivity data for each process, energy consumption data, raw material lot information, external environment data, design information from an equipment manufacturer, traceability information from a parts supplier, and weather and supply and demand data from an external cloud service, and automatically generates an improvement proposal optimized for each site, each location, or across the entire company, such as “addition of a cooling fan of the welding robot is necessary”, “readjustment of an operation parameter of the assembly robot is effective”, “a nozzle cleaning frequency of the painting robot should be increased”, “route optimization of the transfer robot”, “shortening of a camera calibration cycle of the inspection robot”, “standardization of a loading procedure of the palletizing robot”, “optimization of a tool replacement timing of the polishing robot”, “adjustment of a gripping force of the picking robot”, “reinforcement of a worker education program”, “process reorganization for improving an operation rate of equipment”, or “optimization of an operation pattern for reducing energy consumption”. Also considering a past response history or a degree of understanding of a person in charge at the site, it is possible to personalize a content of the proposal, and makes a proposal in line with an actual situation of the site, such as attaching a detailed procedure manual or a video manual to an inexperienced worker, and notifying only a main point to a skilled worker. Specifically, the present data integrated analysis and improvement proposal unit comprises an inference engine having a large language model having tens of billions of parameters as a core. The present data integrated analysis and improvement proposal unit has an embedding layer for mapping data of different formats to a common vector space. The present data integrated analysis and improvement proposal unit converts structured data and unstructured text data into a natural language prompt. The present data integrated analysis and improvement proposal unit supplies the converted natural language prompt to an input layer of the large language model. The input data includes, for example, a numerical vector indicating an equipment operation rate for the past one week, a histogram array indicating an occurrence frequency of an error code, and a text token string extracted from a daily work report. The present large language model specifies a root cause of a potential problem through an autoregressive decoding process. The present large language model outputs a text character string indicating a specific improvement action and a numerical score indicating its expected effect from an output layer. The output data includes, for example, a natural language text indicating a specific procedure of parameter change, a percentage value indicating an expected operation rate improvement range after execution of an improvement measure, and a reference link URI of a related manual. The present data integrated analysis and improvement proposal unit collates the output improvement action with a user profile database. The present data integrated analysis and improvement proposal unit dynamically adjusts a difficulty level of a technical term of an output text according to a skill level of a user. The present data integrated analysis and improvement proposal unit transmits the text after adjustment to the user interface unit. The present large language model is fine-tuned so as to improve validity and safety of a proposal using a human feedback method from reinforcement learning. By this processing, the present system provides advanced decision-making support imitating a thinking process of a skilled engineer beyond mere data visualization. The present system exhibits a technical effect of automating continuous process improvement at the site and dramatically improving production efficiency. The present system provides extremely high value in a use case such as a smart factory performing high-mix low-volume production or a manufacturing site where a shortage of skilled workers is a problem.

The user interface unit provides a screen or a dashboard on which a site worker or a manager can operate and confirm various functions of the system, and enables immediate display of an alert notification, browsing of detailed data when an abnormality occurs, confirmation of a maintenance recommendation, list display of a quality inspection result, reception of an improvement proposal, input of feedback from the site, browsing of a work procedure manual or a video manual, reference to a past response history, and the like. A terminal at the site can be configured in various forms such as a smartphone, a tablet, a wearable terminal, an industrial PC, and AR glasses, and a site worker can immediately confirm an alert or an improvement proposal and input a response status or a work result on the spot. Specifically, the present user interface unit is implemented as a web-based single page application. The present user interface unit establishes WebSocket communication with the server. The present user interface unit asynchronously receives a data payload in a JSON format push-distributed from the server. The present user interface unit analyzes the received data payload and updates a virtual document object model. The present user interface unit reconstructs screen drawing in milliseconds based on the updated virtual document object model. For augmented reality glasses, the present user interface unit generates a hologram drawing command based on a three-dimensional space coordinate system. The present user interface unit tracks a line-of-sight vector of a worker. When the line-of-sight vector and three-dimensional coordinates of a target device intersect, the present user interface unit overlay-displays an operation status of the corresponding device. The present user interface unit acquires a voice input from the worker through a microphone array. The present user interface unit converts the voice input into text data by a natural language processing module. The present user interface unit transmits the converted text data to the server as feedback information. By this processing, the present system realizes intuitive information access without occupying both hands of the worker. The present system minimizes an operation delay of a human-machine interface and exhibits a technical effect of dramatically improving a response speed in an emergency. The present system provides an optimal operation environment in a use case such as a semiconductor manufacturing process in which a non-contact operation in a clean room is required, or an aircraft assembly process involving complicated wiring work.

The data accumulation unit integrally saves all sensor data, image data, acoustic data, an inspection result, an incident log, a maintenance history, a work history, an improvement proposal history, and the like in time series, and utilizes them for future retraining of an AI model, detailed analysis by a human, an audit response, ensuring traceability, and the like. Specifically, the present data accumulation unit adopts a data lake architecture combining a distributed relational database and an object storage for unstructured data. The present data accumulation unit temporarily caches sensor data generated by millions of cases per second in an in-memory database. The present data accumulation unit divides the cached data into a certain chunk size. The present data accumulation unit executes conversion processing into a column-oriented format on the divided chunk. The present data accumulation unit compresses the converted column-oriented data using a high compression algorithm. The present data accumulation unit writes the compressed data to a persistent storage. The present data accumulation unit applies a cryptographic hash function to each data record and gives a digital signature for falsification prevention. When receiving an access request to data, the present data accumulation unit scans an index tree and searches for corresponding data at high speed. The present data accumulation unit decrypts and decompresses the searched data and returns the data to a request source module. Using the accumulated history data, the present data accumulation unit automatically starts a batch retraining process of a neural network during an idle time at night. By this processing, the present system efficiently and safely manages petabyte-class enormous industrial data. The present system exhibits a technical effect of achieving both long-term data storage and a high-speed query response without deteriorating read/write performance of data. The present system functions as an infrastructure that ensures complete traceability in a use case such as pharmaceutical manufacturing or automobile parts manufacturing in which retention of a strict quality assurance record is legally obligated.

A communication control unit controls data transmission and reception between a terminal at a site and a server, between a plurality of locations, and with an external system, and supports various communication protocols and security requirements, such as real-time transfer of sensor data, immediate delivery of an alert notification, batch transmission of image data, cooperation with an external cloud service, information cooperation with an equipment manufacturer or a parts supplier, and acquisition of weather data or power supply and demand data. Specifically, the communication control unit includes a broker module implementing a message queuing telemetry transport protocol. The communication control unit establishes an asynchronous communication session based on a publish-subscribe model with each sensor node. The communication control unit constantly monitors a bandwidth and a delay status of a network. When the bandwidth falls below a specified value, the communication control unit executes adaptive rate control to dynamically reduce a sampling rate of transmission data. The communication control unit applies a multipart upload method using a hypertext transfer protocol secure to a large-capacity payload such as image data. The communication control unit provides an application programming interface based on a representational state transfer architecture in cooperation with the external system. The communication control unit enforces end-to-end encryption by a transport layer security protocol in all communication paths. The communication control unit analyzes header information of a received packet and blocks an unauthorized access request at a firewall layer. By this processing, the system prevents data loss or order reversal even in an unstable in-factory network environment. The system exhibits a technical effect of defending against a cyberattack from the outside while guaranteeing real-time performance of mission-critical control data. The system provides a robust communication infrastructure in a use case such as a global supply chain management system connecting a plurality of overseas factories via a dedicated line or a virtual private network.

Specific examples of a prompt sentence to be read by the generative AI necessary for carrying out the present invention include “detect an abnormal pattern from time-series data of temperature, vibration, torque, and image data of a welding robot, extract data before and after the occurrence of the abnormality, and estimate a cause of the abnormality”, “detect a sign of bearing wear or gear wear from torque, current, and position data of an assembly robot, and predict a recommended timing for next maintenance”, “automatically determine coating unevenness or nozzle clogging from a coated surface image and pressure and flow rate data of a coating robot, and explain a basis for the determination”, “integrally analyze quality inspection results, incident logs, and equipment operation data of all locations, and propose five specific improvement measures for quality improvement and downtime reduction”, and “generate an optimal improvement proposal and procedure manual in consideration of a past response history and a degree of understanding of a site worker”. Specifically, the system includes a prompt engineering module that converts these natural language prompts into a structured query vector inside the system. The prompt engineering module divides the input prompt sentence into word tokens by a morphological analyzer. The prompt engineering module maps each word token to a coordinate value on a high-dimensional vector space using a pre-learned word embedding model. The prompt engineering module adds positional encoding to the mapped vector group. The prompt engineering module supplies the vector group to which the positional encoding is added to an input layer of a large language model. The input data includes, for example, a 512-dimensional token embedding vector array and a summary vector of a past similar case added as context information. The large language model interprets an intention of the input prompt and internally generates an access plan to a necessary data source. The large language model sequentially generates a text token string of an inference result from an output layer. The output data includes, for example, text indicating a logical inference process of the cause of the abnormality, numerical data indicating a specific timestamp section of sensor data serving as the basis for the determination, and a list structure indicating a priority of the improvement measure. The system parses the output text token string and converts it into an executable command script or a display format. By this processing, the system establishes an interface that causes a computer to execute a complex data analysis task via a natural language routinely used by humans. The system exhibits a technical effect that even a site worker having no programming knowledge can utilize an advanced AI function. The system is extremely effective in a use case of realizing an intuitive system operation beyond a language barrier at an international manufacturing site where multiple languages are spoken.

### (Implementation Steps)

Step 1: Multidimensional Collection and Preprocessing of Sensor Data A temperature sensor, a vibration sensor, a torque sensor, a current sensor, an acceleration sensor, a pressure sensor, a humidity sensor, a load sensor, an image acquisition camera, an acoustic sensor, an infrared sensor, a proximity sensor, an encoder, and the like are installed in main components of various robots such as a welding robot, an assembly robot, a transfer robot, a coating robot, an inspection robot, a palletizing robot, a polishing robot, and a picking robot in a factory, and data is collected at a high frequency in units of milliseconds. A terminal at a site temporarily buffers these data, performs preprocessing such as noise removal, abnormal value correction, time synchronization, data compression, and feature amount extraction, and transmits the data to a server. Specifically, in this step, the terminal at the site receives a data stream arriving asynchronously from each sensor. The terminal at the site stores the received data stream in a ring buffer memory. The terminal at the site adds a timestamp with microsecond accuracy to each data point using a network time protocol. The terminal at the site corrects a deviation in sampling period between different sensors by a spline interpolation algorithm based on the timestamp, and generates a time-synchronized multidimensional time-series matrix. The terminal at the site applies a moving median filter to the multidimensional time-series matrix to remove spike noise. The terminal at the site executes a principal component analysis algorithm to reduce the number of dimensions of the multidimensional time-series matrix, and extracts an essential feature amount vector. The terminal at the site compresses the extracted feature amount vector by run-length encoding. The terminal at the site transmits the compressed data packet to the server via a secure communication channel. By this processing, the system significantly reduces a calculation load on the server side and consumption of a network bandwidth. The system exhibits a technical effect of minimizing a delay in data processing by utilizing edge computing technology. The system is an indispensable procedure for constructing a real-time data pipeline in a use case such as a large-scale automobile assembly line in which thousands of sensors operate simultaneously.

Step 2: Robot State Abnormality Detection by Generative AI The generative AI on the server integrally analyzes multidimensional data such as a time-series fluctuation pattern of temperature, a frequency spectrum of vibration, a peak value and a fluctuation range of torque, edge detection and a color histogram of an image, spectrogram analysis of sound, a minute fluctuation of pressure, a distribution of load, and an abnormal pattern of acceleration, and automatically detects an abnormal value or an abnormal tendency. For example, when an abnormality is detected, such as when an arm temperature of a welding robot continues to be 10 degrees or more higher than normal, when vibration of a joint portion of an assembly robot rapidly increases in a specific frequency band, or when a drive wheel torque of a transfer robot repeatedly rapidly increases and decreases at a constant cycle, an immediate alert is issued to a terminal of a person in charge at the site or a manager, and data before and after the occurrence of the abnormality, related sensor data, an operation log of the robot, a work instruction history, and the like are automatically recorded and saved. A specific example of a prompt sentence to be read by the generative AI is “detect an abnormal pattern from time-series data of temperature, vibration, torque, and image data of a welding robot, extract data before and after the occurrence of the abnormality, and estimate a cause of the abnormality”. Specifically, in this step, the server supplies the received feature amount vector to an input layer of an autoencoder-type neural network. The input data includes, for example, a 256-dimensional multi-sensor integrated feature amount vector and a context tensor indicating an operation state for the past one hour. The autoencoder-type neural network compresses the input data into a low-dimensional latent space vector in an encoder layer. The autoencoder-type neural network reconstructs the original feature amount vector from the latent space vector in a decoder layer. The server calculates a reconstruction error between the input feature amount vector and the reconstructed feature amount vector. When the reconstruction error exceeds a dynamically set threshold value, the server determines that an unknown abnormal pattern has occurred. Simultaneously with the abnormality determination, the server issues a prompt instructing a large language model to perform a task of estimating the cause of the abnormality. The large language model outputs an inference result of a root cause of the abnormality and a recommended initial response procedure from an output layer. The output data includes, for example, a specific result of a sensor channel having a large reconstruction error, a score indicating a severity of the abnormality, and a control command character string instructing an emergency stop. The server analyzes the output control command character string and transmits a stop signal to a programmable logic controller of the corresponding robot. By this processing, the system autonomously discovers an unknown failure mode that cannot be handled by a predefined rule-based threshold value determination. The system exhibits a technical effect of shortening a lead time from the occurrence of the abnormality to a response to the utmost limit and preventing secondary damage. The system achieves both high safety and maintenance of an operation rate in a use case such as a welding process in which articulated robots having complex mechanisms operate densely.

Step 3: Predictive Maintenance and Failure Prediction by Generative AI Time-series data obtained from a robot state monitoring unit is accumulated and analyzed over a long period of time by the generative AI, and a deterioration tendency or a sign of failure or deterioration of a machine for each equipment is predicted with high accuracy. For example, the generative AI estimates a failure probability or a remaining life for each equipment, such as detecting wear of an arm bearing of a welding robot from a harmonic component or an amplitude increase of vibration data, detecting gear wear of a drive unit of an assembly robot from an abnormal fluctuation of a torque value or a current value, and predicting brush wear or gear wear of a motor of a transfer robot by composite analysis of temperature, current, and acceleration data, and automatically notifies a terminal of a person in charge at the site or a person in charge of maintenance of a specific prediction result. A specific example of a prompt sentence to be read by the generative AI is “detect a sign of bearing wear or gear wear from torque, current, and position data of an assembly robot, and predict a recommended timing for next maintenance”. Specifically, in this step, the server supplies the accumulated time-series data to an input layer of a recurrent neural network as batch processing. The input data includes, for example, an array of daily average torque values for the past one month, a peak frequency transition vector of a vibration spectrum, and a scalar value of a cumulative operation time. The recurrent neural network calculates a temporal state transition while holding a past internal state in a hidden layer. The recurrent neural network mathematically fits a deterioration curve of a part in cooperation with a Weibull distribution model. The recurrent neural network outputs a transition curve of a failure occurrence probability at a specific point in time in the future from an output layer. The output data includes, for example, a floating-point array indicating a daily failure probability for the next 30 days, a numerical value indicating an expected value of the remaining life, and an upper limit value and a lower limit value indicating a confidence interval of the prediction. The server specifies a date when the output failure probability exceeds an allowable risk level. The server formulates an optimal maintenance schedule based on the specified date. The server automatically links the formulated schedule to an enterprise resource planning system. By this processing, the system realizes a transition from periodic time-based maintenance to condition-based maintenance based on an actual equipment state. The system exhibits a technical effect of eliminating a production loss due to a sudden equipment stop and optimizing a maintenance cost. The system greatly contributes to stabilization of a supply chain in a use case such as a manufacturing site operating a special industrial robot having a long parts procurement lead time.

Step 4: Automatic Quality Inspection and Defective Product Determination by Generative AI Quality inspection data, a product image, and various sensor data of work performed by each robot are multilaterally analyzed by the generative AI, and a defective product or a quality abnormality is automatically detected with high accuracy. For example, an inspection result or defective product data is centrally managed by a server and displayed in real time to a worker on a terminal at a site, such as detecting a minute crack or poor welding from a weld bead image of a welding robot, determining poor tightening or an assembly error of a part from tightening torque or position data of an assembly robot, and detecting coating unevenness or foreign matter adhesion from a coated surface image of a coating robot. A specific example of a prompt sentence to be read by the generative AI is “automatically determine coating unevenness or nozzle clogging from a coated surface image and pressure and flow rate data of a coating robot, and explain a basis for the determination”. Specifically, in this step, the server supplies the product image and the sensor data to an input layer of a multimodal neural network in synchronization. The input data includes, for example, a high-resolution RGB image tensor of 2048 pixels square and a one-dimensional time-series array indicating a spray pressure during coating. The multimodal neural network includes a convolutional layer for extracting an image feature and a self-attention mechanism layer for time-series data in parallel. The multimodal neural network combines the extracted image feature amount vector and the time-series feature amount vector in a combining layer to form an integrated feature amount space. The multimodal neural network outputs a binary classification result of quality determination and a heat map of an abnormal portion from an output layer. The output data includes, for example, a Boolean value indicating a non-defective product or a defective product, a two-dimensional probability map highlighting a defect area on the image, and a text label indicating that a factor of the defect is a pressure drop. The server displays the output heat map superimposed on the product image on a display of the terminal at the site. When it is determined as a defective product, the server registers a serial number of the corresponding product in a defective product database. By this processing, the system accurately detects a complex quality abnormality that cannot be discriminated by a single data source by fusing visual information and physical sensor information. The system exhibits a technical effect of improving a yield of an inspection process and completely preventing an outflow of a defective product to a market. The system exhibits extremely high inspection accuracy in a use case such as a final assembly process of a smartphone or a tablet terminal in which an appearance inspection and an internal structure inspection need to be performed simultaneously.

Step 5: Data Integrated Analysis and Improvement Proposal Generation by Generative AI All data collected from a robot state monitoring unit, a predictive maintenance unit, and an automatic quality management unit are integrally analyzed by the generative AI on a server, a tendency or a problem for each robot or each process is extracted, and a specific improvement measure is automatically generated. For example, the generative AI analyzes multidimensional data such as a past incident log, a quality inspection result, a maintenance history, an equipment operation status, an operation history of a worker, productivity data for each process, energy consumption data, raw material lot information, and external environment data, and automatically generates an improvement proposal optimized for each site, each location, or across an entire company, such as “addition of a cooling fan”, “readjustment of an operation parameter”, “increase in nozzle cleaning frequency”, and “route optimization”. A specific example of a prompt sentence to be read by the generative AI is “integrally analyze quality inspection results, incident logs, and equipment operation data of all locations, and propose five specific improvement measures for quality improvement and downtime reduction”. Specifically, in this step, the server supplies the accumulated multidimensional data to an input layer of a graph neural network. The input data includes, for example, graph structure data in which each equipment is a node and a physical connection or data dependency between equipment is an edge, and a feature amount vector indicating an operation rate or an error rate assigned to each node. The graph neural network propagates feature amount information between adjacent nodes using a message passing algorithm. The graph neural network specifies a process or equipment that is a bottleneck of the entire factory based on an index of network centrality. The server inputs the specified bottleneck information to a large language model and requests generation of an improvement measure. The large language model outputs a list of specific improvement actions and a simulation result of cost-effectiveness of each action from an output layer. The output data includes, for example, a JSON object indicating a specific numerical setting of a parameter change, a predicted value indicating a throughput improvement rate after introduction of the improvement measure, and numerical data indicating an investment recovery period. The server displays the output improvement proposal on a dashboard of a manager in order of priority. By this processing, the system mathematically derives global optimization of the entire factory instead of local optimization. The system exhibits a technical effect of establishing a data-driven continuous improvement process that does not depend on human rules of thumb. The system supports strategic decision-making for maximizing efficiency of an entire production line in a use case such as a semiconductor wafer manufacturing factory in which hundreds of processes are complexly intertwined.

Step 6: Notification, Feedback, and Site Response by User Interface Through a user interface unit, a screen or a dashboard on which a site worker or a manager can operate and confirm various functions of the system is provided, enabling immediate display of an alert notification, browsing of detailed data when an abnormality occurs, confirmation of a maintenance recommendation, list display of a quality inspection result, reception of an improvement proposal, input of feedback from a site, browsing of a work procedure manual or a video manual, reference to a past response history, and the like. When the site worker immediately confirms the alert or the improvement proposal, inputs a response status or a work result on the spot, and feeds it back to a server, the generative AI continuously learns an actual situation of the site, thereby realizing highly accurate abnormality detection or improvement proposal. Specifically, in this step, the terminal at the site pops up and displays the alert notification received from the server on the forefront of the screen using a push notification function of an operating system. When the worker taps the alert, the terminal at the site renders a detailed screen integrating a three-dimensional CAD model of the corresponding equipment and real-time sensor data. The terminal at the site acquires an inspection result or a fact of parts replacement performed by the worker via a check box on a touch panel or a voice input interface. The terminal at the site converts the acquired work result data into a structured JSON format. The terminal at the site transmits the converted JSON data to a feedback reception application programming interface of the server. The server stores the received feedback data in a database as a correct answer label. The server finely adjusts a weight parameter of an abnormality detection model and an improvement proposal model by a gradient descent method using the accumulated correct answer label. By this processing, the system constructs a human-in-the-loop mechanism that self-evolves inference accuracy of an AI model through operation of the system. The system exhibits a technical effect of incorporating tacit knowledge of the site into the system as explicit knowledge and improving an adaptive capability to an environmental change. The system prevents obsolescence of the system and always maintains optimal performance in a use case such as an agile manufacturing site where a process is frequently changed in a launch period of a new product.

### (Specific Use Case)

For example, when the factory robot autonomous safety and quality optimization system of the present invention is applied in an assembly factory for automobile parts, a wide variety of robots such as an assembly robot, a welding robot, a transfer robot, a coating robot, an inspection robot, a palletizing robot, a polishing robot, and a picking robot are arranged in a plurality of processes. A temperature sensor, a vibration sensor, a torque sensor, a current sensor, an acceleration sensor, a pressure sensor, a load sensor, an image acquisition camera, an acoustic sensor, an infrared sensor, an encoder, and the like are installed in each robot, and optimal data for each process, such as temperature and vibration of an arm unit of the welding robot, torque and a current value of a joint unit of the assembly robot, acceleration and load of a driving wheel of the transfer robot, nozzle pressure and coating thickness of the coating robot, a camera image and acoustic data of the inspection robot, gripper load and a loading image of the palletizing robot, a spindle rotation speed and a surface image of the polishing robot, and suction pressure and gripping force of the picking robot, are collected in real time in units of milliseconds. A site terminal temporarily buffers these data, performs preprocessing such as noise removal, abnormal value correction, time synchronization, data compression, and feature amount extraction, and transmits the data to a server. Specifically, in this application example, the system is deployed on an engine block assembly line of an automobile. The site terminal functions as an edge computing device incorporated in a control panel of each robot. The site terminal acquires control data from a programmable logic controller via an industrial Ethernet protocol. The site terminal directly samples an analog signal from an externally attached high-precision sensor group. The site terminal applies a low-pass filter to the acquired raw data to attenuate a high-frequency noise component. The site terminal applies a linear interpolation algorithm to a missing value to ensure continuity of a data array. The site terminal maps a data stream of each sensor to a common time base to construct a multidimensional time-series tensor. The site terminal executes a wavelet transform on the time-series tensor to generate a feature amount matrix in a time-frequency domain. The site terminal compresses the generated feature amount matrix by a lossless compression algorithm and performs streaming transmission to the server. By this processing, the system extracts only a meaningful feature from an enormous amount of sensor data and avoids network congestion. The system exhibits a technical effect of ensuring real-time performance of data processing in a high-speed assembly line requiring a control cycle in units of milliseconds. The system provides a robust data collection infrastructure for immediately capturing a minute operation abnormality in a use case such as a welding process of an automobile body in which an articulated robot performs a complex cooperative operation.

The generative AI on the server detects an abnormal pattern from time-series fluctuations of temperature, vibration, torque, and image data of the welding robot, for example, and automatically records and saves data before and after the occurrence of the abnormality, related sensor data, an operation log of the robot, and a work instruction history. The generative AI detects a sign of bearing wear or gear wear from torque, current, and position data of the assembly robot, and predicts a next recommended maintenance timing. The generative AI detects a sign of brush wear or gear wear from motor temperature, current, and acceleration data of the transfer robot, automatically determines coating unevenness or nozzle clogging from a coated surface image and pressure and flow rate data of the coating robot, and explains a basis for the determination. The generative AI determines a dimensional abnormality or an appearance defect by image recognition of the inspection robot, detects a loading mistake or a load collapse risk from a loading state image of the palletizing robot, detects a polishing defect or tool wear from a surface finish image and vibration data of the polishing robot, and detects an abnormality in gripping pressure or suction pressure of the picking robot. When a defective product or a quality abnormality is detected, the corresponding product is removed or marked from the line, an inspection result and defective product data are centrally managed by the server and displayed in real time to a worker on the site terminal, and the worker can also perform reinspection or correction work on the spot. Specifically, the server supplies the received feature amount matrix to an input layer of a deep learning-based abnormality detection model. Input data includes, for example, a 64-dimensional torque fluctuation vector, a 128-dimensional vibration spectrum array, and a high-resolution welding bead image tensor. The abnormality detection model adopts an ensemble learning architecture combining a support vector machine and a convolutional neural network. The abnormality detection model calculates a distance from a hyperplane learned from a normal data distribution, and calculates an abnormality score based on a Mahalanobis distance. The abnormality detection model outputs an abnormality probability of each equipment and a classification label of a quality defect from an output layer. Output data includes, for example, a percentage value indicating a progress degree of gear wear, a pixel coordinate group indicating an occurrence position of coating unevenness, and an explanatory text in natural language of a cause of the defect. When the output abnormality probability exceeds a specified threshold value, the server transmits an interlock signal to a control unit of the corresponding robot to safely pause the operation. The server drives a solenoid valve of a discharge shooter based on a defective product determination result to guide the defective product to a reject box. By this processing, the system replaces quality inspection and equipment diagnosis, which have relied on human senses, with a quantitative mathematical model. The system exhibits a technical effect of physically blocking an outflow of a defective product to a next process and dramatically improving certainty of quality assurance. The system provides extremely high reliability in a use case such as a cutting and polishing process of a transmission part requiring processing accuracy in units of microns.

Furthermore, the generative AI integrally analyzes multidimensional data such as a past incident log, a quality inspection result, a maintenance history, an equipment operation status, an operation history of a worker, productivity data for each process, energy consumption data, raw material lot information, external environment data, design information from an equipment manufacturer, traceability information from a parts supplier, and weather and supply-demand data from an external cloud service, and automatically generates an improvement measure optimized for each site, each location, or across the entire company, such as “addition of a cooling fan for the welding robot”, “readjustment of an operation parameter of the assembly robot”, “increase in nozzle cleaning frequency of the coating robot”, “route optimization of the transfer robot”, “shortening of a camera calibration cycle of the inspection robot”, “standardization of a loading procedure of the palletizing robot”, “optimization of tool replacement timing of the polishing robot”, “adjustment of gripping force of the picking robot”, “reinforcement of a worker education program”, “process reorganization for improving an equipment operation rate”, and “operation pattern optimization for reducing energy consumption”. It is also possible to personalize a content of the proposal in consideration of a past response history and a degree of understanding of a person in charge at the site, and a proposal conforming to an actual situation of the site is made, such as attaching a detailed procedure manual or a video manual to an inexperienced worker and notifying only main points to an expert. Specifically, the server structures these multidimensional data as a knowledge graph and stores the knowledge graph in a graph database. The server learns a relationship between nodes on the knowledge graph using a graph attention network. The server injects the learned graph embedding vector as a prompt context of a large language model. Input data includes, for example, a statistical vector indicating a correlation between a specific raw material lot and a defect occurrence rate, a text embedding vector indicating a resolution procedure of a similar trouble in the past, and a tensor indicating a current temperature and humidity distribution in the factory. The large language model infers a hidden causal relationship between seemingly unrelated events using a self-attention mechanism of a transformer architecture. The large language model outputs a step-by-step execution plan of a specific improvement measure from an output layer. Output data includes, for example, a modified code snippet of a control program of the robot, a list of optimal parameter setting values, and a text of a customized training manual for the worker. The server collates the output execution plan with profile data indicating a skill level of the worker, and dynamically filters an information amount to be displayed and a level of technical terms. By this processing, the system extracts a hint for global optimization that cannot be noticed by a human from an enormous data group. The system exhibits a technical effect of strongly promoting a continuous improvement activity at the site in a data-driven manner and maximizing overall equipment effectiveness of the entire factory. The system functions as a powerful knowledge management infrastructure in a use case of a global manufacturing company that shares best practices among a plurality of factories and aims to improve company-wide productivity.

Specific examples of a prompt sentence to be read by the generative AI include “Detect an abnormal pattern from time-series data of temperature, vibration, torque, and image data of a welding robot, extract data before and after the occurrence of an abnormality, and estimate a cause of the abnormality”, “Detect a sign of bearing wear or gear wear from torque, current, and position data of an assembly robot, and predict a next recommended maintenance timing”, “Automatically determine coating unevenness or nozzle clogging from a coated surface image and pressure and flow rate data of a coating robot, and explain a basis for the determination”, “Integrally analyze quality inspection results, incident logs, and equipment operation data of all locations, and propose five specific improvement measures for quality improvement and downtime reduction”, and “Generate an optimal improvement proposal and procedure manual in consideration of a past response history and a degree of understanding of a site worker”. Specifically, the system transmits these prompt sentences to an inference endpoint of a large language model via an application programming interface. The system adds a numerical array obtained by cutting out a specific time window of target sensor data as context data together with the prompt sentence. Input data includes, for example, a task instruction text described in natural language, and a time-series data set of a current value and a vibration value for the past ten minutes formatted in a comma-separated format. The large language model processes the input text and numerical data on the same latent space, and executes cross-modal inference. The large language model generates structured response data in a JSON format from an output layer. Output data includes, for example, a character string field indicating an inference result of the cause of the abnormality, a time stamp field indicating a recommended maintenance date and time, and an array field indicating a threshold excess point of the sensor data serving as the basis for the determination. The system parses the received JSON data, stores the inference result in a corresponding table of a database, and passes the data to a drawing engine of a user interface. By this processing, the system seamlessly integrates an unstructured natural language instruction and structured sensor data, and automates an advanced analysis task. The system exhibits a technical effect of being able to immediately execute flexible data analysis according to needs of the site without describing complex programming. The system provides extremely high agility in a use case of high-mix variable-volume production in which it is necessary to quickly adapt an analysis logic to daily changing production items and new quality issues.

In this way, the factory robot autonomous safety and quality optimization system of the present invention centrally and autonomously realizes real-time monitoring, abnormality detection, predictive maintenance, automatic quality management, data integrated analysis, and improvement proposal of a wide variety of robots across a plurality of processes and a plurality of locations, and can dramatically improve safety, quality, production efficiency, maintenance efficiency, and site responsiveness at the site. Specifically, the system is configured by a distributed computing architecture in which an edge device group and a cloud server group operate in cooperation with each other. The system processes petabyte-class multidimensional data collected from each robot in real time and integrally using a deep learning model and a large language model. The system integrates various sensor modalities in an input layer, extracts a non-linear correlation in a high-dimensional feature space in a hidden layer, and generates a specific control command and an optimized improvement proposal in an output layer. Input data includes, for example, a real-time multidimensional tensor indicating an operation status of the entire factory, and structured data indicating a past maintenance history of each equipment. The system outputs a set of optimal operation parameters of each equipment and a probability distribution of a predicted failure risk from the output layer. Output data includes, for example, a numerical array indicating an operation speed and a torque limit value of the robot, and a percentage value indicating a downtime occurrence probability for the next week. The system automatically feeds back the output parameter set to a control device of each robot to realize autonomous closed-loop control. By this processing, the system simultaneously optimizes an enormous number of variables exceeding human cognitive limits, and mathematically streamlines the operation of the entire factory to the utmost limit. The system exhibits a technical effect of constructing an autonomous production system in which a manufacturing process itself self-learns and evolves beyond mere automation. The system plays an indispensable and core role in a use case as a foundation system of a next-generation manufacturing industry in a developed country where a labor shortage is becoming serious, and in realization of a fully automated smart factory aimed at by Industry 4.0.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

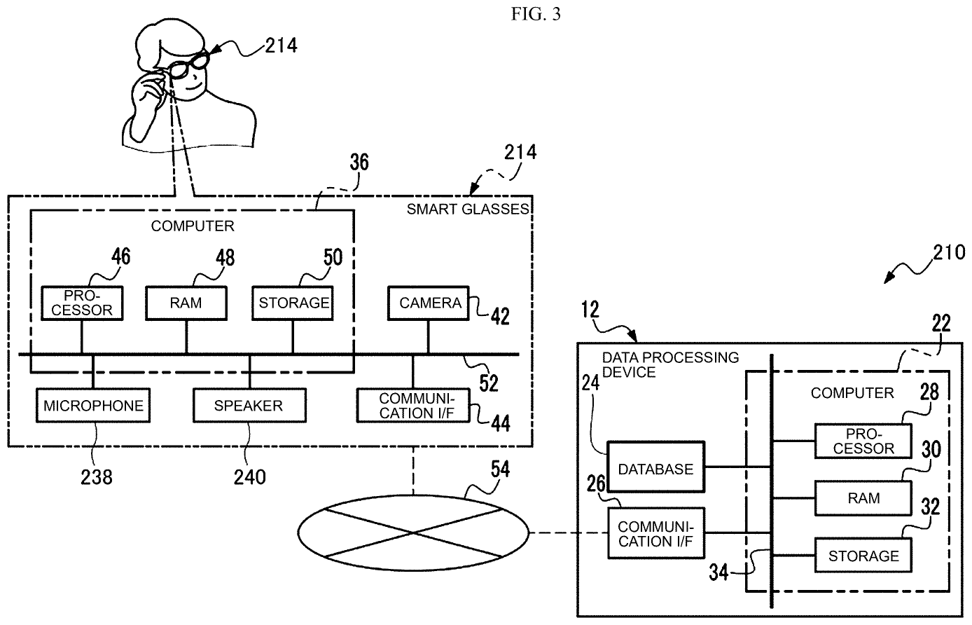

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

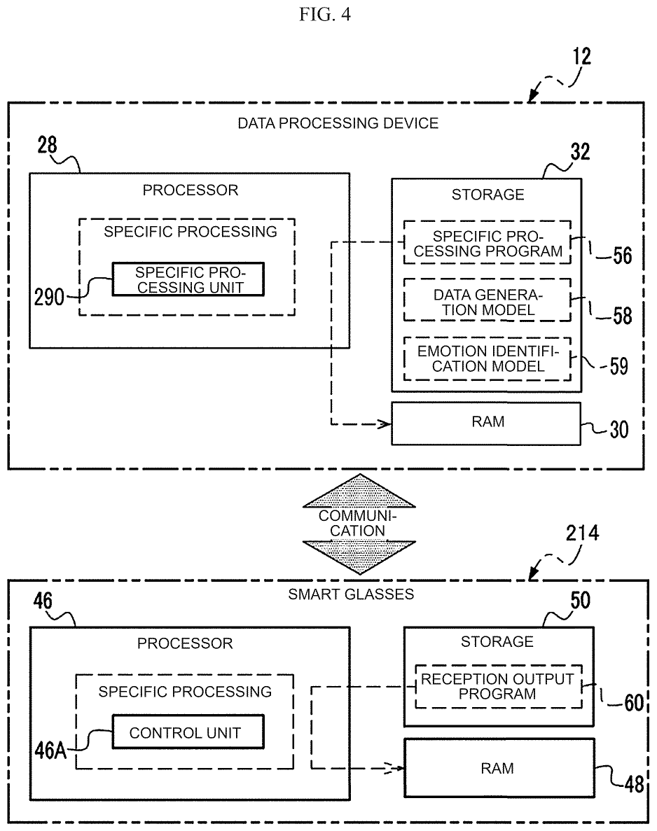

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### EXAMPLE 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

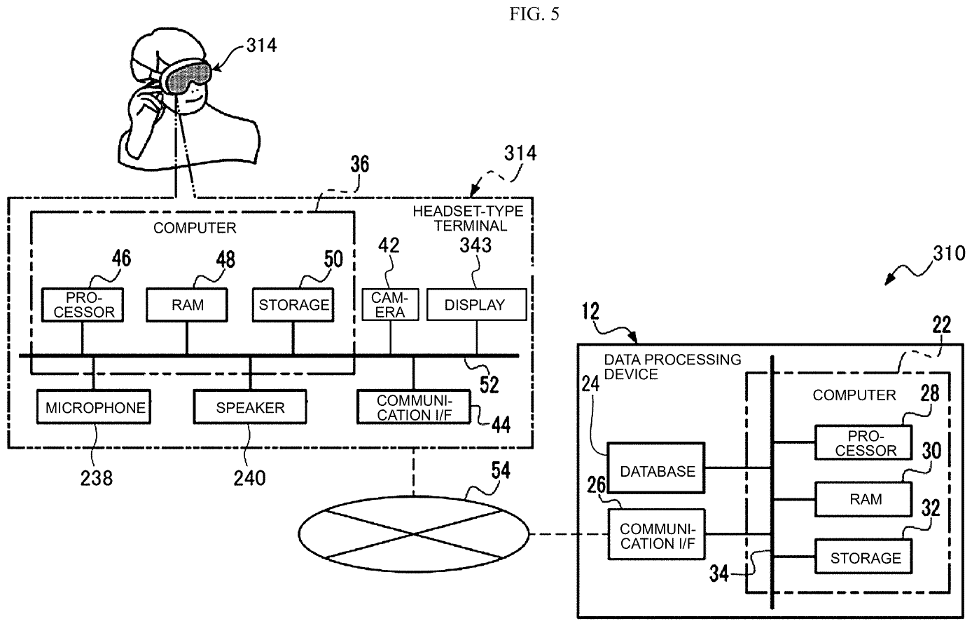

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

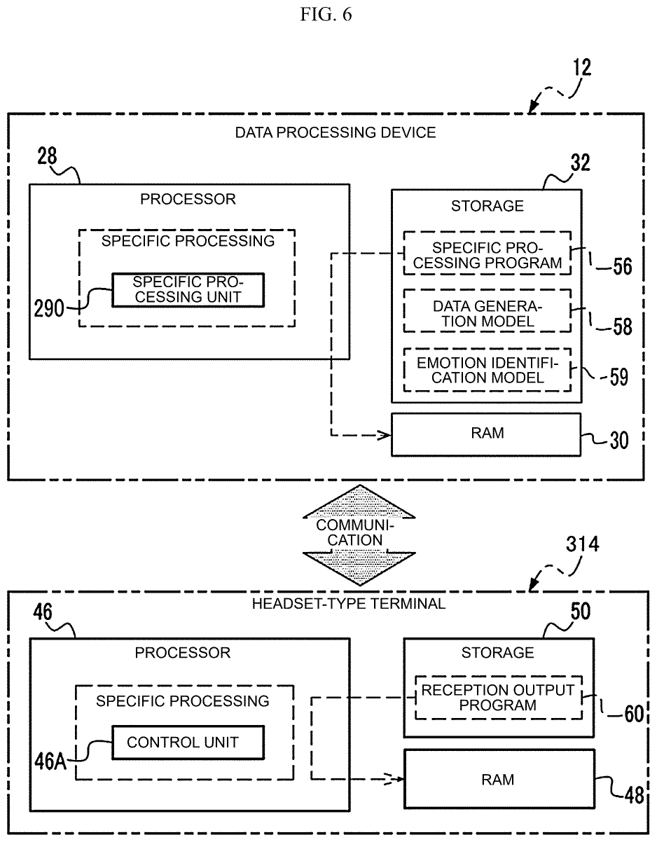

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

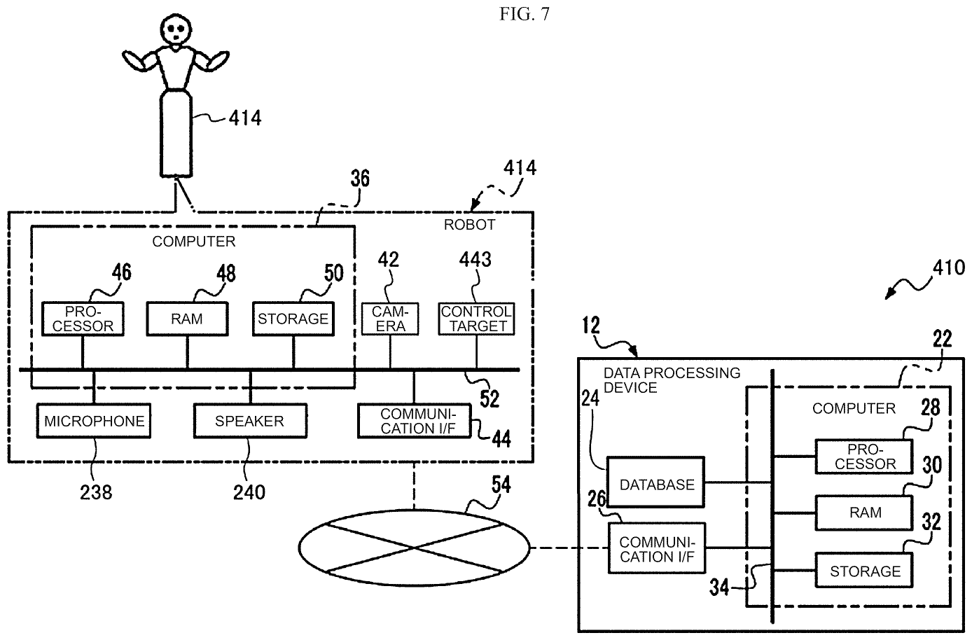

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

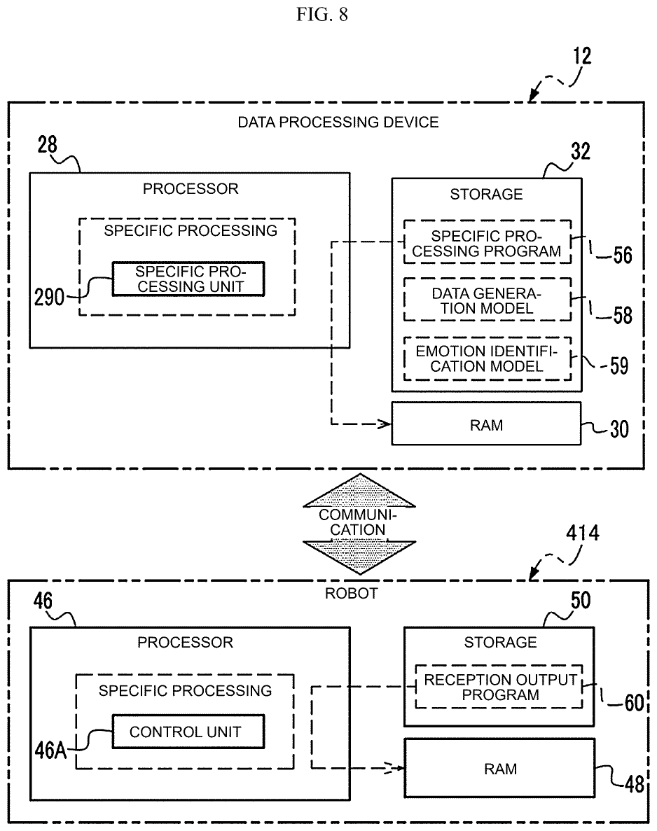

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

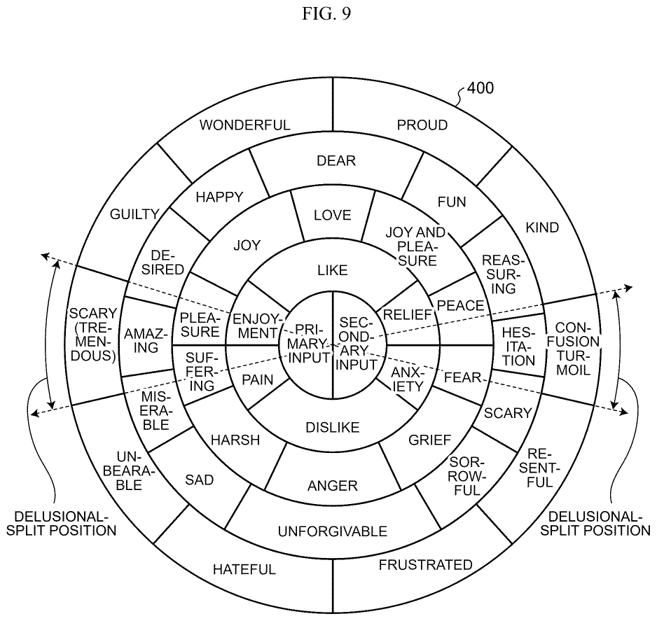

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

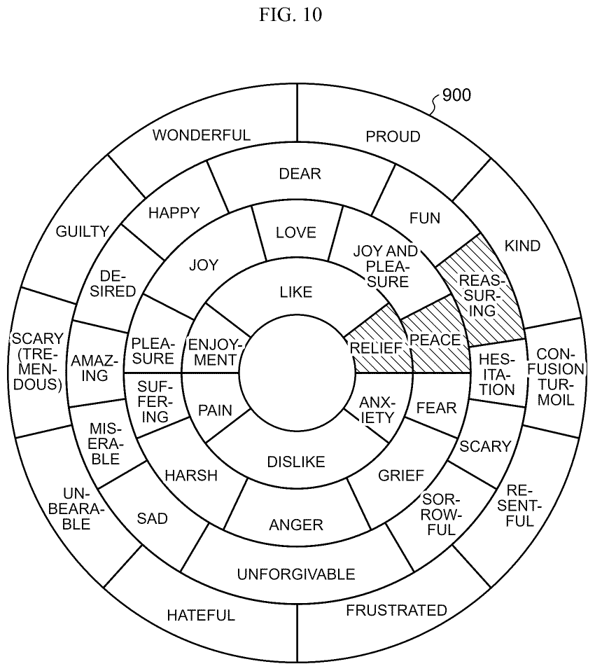

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A factory robot autonomous safety and quality optimization system comprising: a robot state monitoring unit; a predictive maintenance unit; an automatic quality management unit; and a data integrated analysis and improvement proposal unit, wherein the robot state monitoring unit has a function of integrally analyzing various sensor data acquired in real time from a temperature sensor, a vibration sensor, a torque sensor, a current sensor, an image acquisition camera, an acoustic sensor, and the like installed in a plurality of factory robots using generative AI, and automatically detecting an abnormal value or an abnormal tendency of temperature, vibration, torque, an operation pattern, peripheral environment data, and the like of each robot to issue an alert; the predictive maintenance unit has a function of learning and analyzing time-series data obtained from the robot state monitoring unit over a long period of time using the generative AI, predicting a sign of failure or deterioration for each equipment such as bearing wear, deterioration of a drive unit, torque abnormality, vibration increase, and abnormal fluctuation of a current value with high accuracy, and determining and notifying a necessity of maintenance at an appropriate timing; the automatic quality management unit has a function of multilaterally analyzing quality inspection data, a product image, and various sensor data of work performed by each robot using the generative AI, automatically detecting various quality abnormalities such as poor welding, poor tightening, uneven coating, missing parts, foreign matter contamination, dimensional abnormality, and poor assembly with high accuracy, and removing or marking a corresponding product from a line; the data integrated analysis and improvement proposal unit has a function of integrally analyzing all data collected from the respective units using the generative AI, extracting a tendency or a problem for each robot or each process, automatically generating a specific improvement measure such as addition of a cooling fan, readjustment of an operation parameter, advancing of a periodic inspection, standardization of a work procedure, optimization of equipment layout, and reinforcement of worker education, and proposing the specific improvement measure to a person in charge at the site or a manager; and all of these functions automatically operate while cooperating with each other using the generative AI.

### (Supplementary Note 2)

The factory robot autonomous safety and quality optimization system according to Supplementary Note 1, wherein the robot state monitoring unit has a function of integrally analyzing sensor data such as temperature, vibration, torque, current, image, and sound collected from a wide variety of factory robots arranged at a plurality of locations or a plurality of processes in time series using the generative AI, dynamically optimizing a threshold value for abnormality detection and a determination logic, immediately issuing an alert notification to a terminal of the person in charge at the site or a dashboard of the manager when an abnormality occurs, automatically recording and saving data before and after the occurrence of the abnormality, a related work history, and an equipment operation status, and accumulating the data in a database in a form usable for subsequent cause analysis and formulation of a recurrence prevention measure.

(Supplementary Note 3)

The factory robot autonomous safety and quality optimization system according to Supplementary Note 1, wherein the data integrated analysis and improvement proposal unit has a function of comprehensively analyzing multidimensional data such as a past incident log, a quality inspection result, a maintenance history, an equipment operation status, an operation history of a worker, productivity data for each process, energy consumption data, raw material lot information, and external environment data using the generative AI, automatically generating an optimal improvement measure or preventive maintenance measure for each robot, each process, or each location, further personalizing a content of the proposal according to a degree of understanding of the person in charge at the site or the manager or a past response history, and autonomously promoting a continuous improvement cycle.

What is claimed is:

1. A system comprising:
circuitry configured to:
receive, via a communication interface coupled to a packet-switched network, a multidimensional state vector from a robot control device comprising joint angle values, angular velocity values, and motor torque values, and simultaneously receive an environmental parameter vector comprising temperature, humidity, and atmospheric pressure values from environmental sensor devices, and store the received data in a storage device;
apply a hybrid control model comprising a deep reinforcement learning algorithm to the multidimensional state vector and the environmental parameter vector to compute an optimal control action vector that maximizes a safety and quality objective function, and transmit the optimal control action vector to the robot control device via the communication interface;
apply an autoencoder anomaly detection model to the multidimensional state vector to compute a reconstruction error score, detect an anomaly signal when the reconstruction error score exceeds an anomaly threshold parameter, and apply a convolutional neural network to image tensor data from imaging devices to detect product quality deviation events; and
generate an alert data record when an anomaly signal or a quality deviation event is detected, apply a generative neural network model to generate a maintenance recommendation data record, and transmit the alert data record and maintenance recommendation data record to terminal devices via the communication interface.

2. The system according to claim 1, wherein the circuitry is configured to receive the multidimensional state vector at edge computing nodes proximate to the robot control device, apply a lightweight inference model to perform initial anomaly scoring at the edge computing node, and transmit the multidimensional state vector and the initial anomaly score to a cloud computing node via the communication interface for full deep reinforcement learning model inference.

3. The system according to claim 2, wherein the circuitry is configured to apply the deep reinforcement learning algorithm at the cloud computing node by encoding the multidimensional state vector and the environmental parameter vector as a combined input state representation, computing a Q-value estimate for each possible control action, selecting the action maximizing the expected cumulative reward, and transmitting the selected optimal control action vector to the robot control device with a latency below a real-time control threshold.

4. The system according to claim 1, wherein the circuitry is configured to apply the autoencoder anomaly detection model by encoding the multidimensional state vector into a low-dimensional latent representation and decoding it to reconstruct a predicted state vector, computing the reconstruction error as a mean squared error between the input and reconstructed state vectors, and comparing the reconstruction error against an anomaly threshold derived from normal operating condition statistics.

5. The system according to claim 4, wherein the circuitry is configured to apply a one-dimensional convolutional neural network to time-series arrays of the multidimensional state vector to extract vibration and torque pattern features, apply a long short-term memory network to the extracted features to generate multi-step ahead prediction values, and generate a prognostic maintenance indicator when predicted degradation trend metrics exceed a maintenance threshold parameter.

6. The system according to claim 1, wherein the circuitry is configured to apply the convolutional neural network to image tensor data from product inspection imaging devices to extract quality feature vectors comprising surface defect probability scores and dimensional deviation metrics, compare the quality feature vectors against acceptance criterion records stored in the storage device, and generate a quality deviation event record when a quality feature value falls outside the acceptance criterion range.

7. The system according to claim 6, wherein the circuitry is configured to apply a multi-class classification model to the quality deviation event record to generate a defect type identifier and a defect severity score, and incorporate the defect type identifier and the defect severity score in the alert data record transmitted to terminal devices.

8. The system according to claim 1, wherein the circuitry is configured to apply the generative neural network model to the anomaly signal and historical maintenance records retrieved from a vector database by cosine similarity search to generate the maintenance recommendation data record comprising a root cause candidate sequence, a recommended maintenance action sequence, and an estimated time-to-failure value.

9. The system according to claim 1, wherein the circuitry is configured to apply a process deviation detection model to the optimal control action vector time series by comparing observed action sequences against expected action sequence templates, generate a process deviation alert when a significant deviation is detected, and incorporate the process deviation alert as an additional indicator in the alert data record.

10. The system according to claim 1, wherein the circuitry is configured to aggregate anomaly signals, quality deviation events, and maintenance indicators across all monitored equipment identifiers, apply the generative neural network model to the aggregated data to generate a portfolio-level safety and quality insight report, and transmit the report to terminal devices associated with management user identifiers.

11. The system according to claim 1, wherein the circuitry is configured to apply an energy optimization model to the optimal control action vector and the environmental parameter vector to compute an energy consumption prediction, minimize energy consumption in the control action selection process subject to maintaining safety and quality objective function values above minimum threshold parameters.

12. The system according to claim 1, wherein the circuitry is configured to generate a real-time monitoring dashboard data record comprising equipment state heat maps derived from the multidimensional state vector, quality trend charts, and anomaly indicator timelines, and transmit the dashboard data record to terminal devices associated with site management user identifiers via the communication interface.

13. The system according to claim 1, wherein the circuitry is configured to update the deep reinforcement learning algorithm by generating experience tuples from historical state vectors, control action vectors, and corresponding outcome reward values, and updating the Q-network weights using a temporal difference learning procedure to improve control policy accuracy.

14. The system according to claim 1, wherein the circuitry is configured to encrypt data transmissions between the robot control device, IoT sensor devices, and the system using a transport layer security protocol, and authenticate the robot control device using a device certificate prior to accepting multidimensional state vectors for processing.

15. The system according to claim 1, wherein the circuitry is configured to store all multidimensional state vectors, control action vectors, anomaly signals, and quality deviation event records in a long-term archive data structure in the storage device with timestamps and equipment identifiers, and generate a trend analysis report from the archived data for transmission to maintenance management terminal devices.

16. The system according to claim 1, wherein the circuitry is configured to apply a worker safety monitoring model to personnel position tracking data and the equipment operational state derived from the optimal control action vector to detect human proximity risk conditions, and transmit a safety alert to terminal devices when a proximity risk threshold is exceeded.

17. The system according to claim 1, wherein the robot control device controls automated equipment at a manufacturing facility, the multidimensional state vector represents the equipment's mechanical state, the environmental parameter vector represents facility conditions, and the optimal control action vector specifies real-time control adjustments maximizing safety and quality outcomes.

18. A system comprising:
circuitry configured to:
receive, via a communication interface coupled to a packet-switched network, a multidimensional state vector from a robot control device and environmental parameter vectors from sensor devices;
apply a deep reinforcement learning algorithm to compute an optimal control action vector and transmit it to the robot control device in real time;
apply an autoencoder anomaly detection model to detect operational anomalies and a convolutional neural network to detect product quality deviation events;
apply a generative neural network model to generate maintenance recommendation data records from anomaly signals and historical records retrieved by cosine similarity; and
transmit alert data records and maintenance recommendations to terminal devices via the communication interface.

19. The system according to claim 18, wherein the circuitry is configured to apply a one-dimensional convolutional neural network and long short-term memory network to generate prognostic maintenance indicators, apply an energy optimization model to minimize consumption in control action selection, and generate a portfolio-level safety and quality insight report from aggregated anomaly signals and quality deviation events.

20. A method comprising:
receiving, via a communication interface coupled to a packet-switched network, a multidimensional state vector from a robot control device and environmental parameter vectors from sensor devices, and storing the data in a storage device;
applying a deep reinforcement learning algorithm to compute an optimal control action vector and transmitting the vector to the robot control device;
applying an autoencoder anomaly detection model to detect anomaly signals and a convolutional neural network to detect quality deviation events;
generating an alert data record and applying a generative neural network model to generate a maintenance recommendation data record; and
transmitting the alert data record and maintenance recommendation data record to terminal devices via the communication interface.
